(19) United States
(12) Patent Application Publication
(10) Pub. No.: US 2026/0336282 A1
(43) Pub. Date: Oct. 29, 2026

(54) Printing Apparatus

(71) Applicant: SEIKO EPSON CORPORATION, Tokyo (JP)

(72) Inventor: Hirofumi TERASAWA, Okaya (JP)

(21) Appl. No.: 19/631,105

(22) Filed: Mar. 27, 2026

(30) Foreign Application Priority Data
Mar. 28, 2025 (JP) 2025-056169

(51) Int. Cl. B41J 2/045

(52) U.S. Cl. CPC B41J 2/04541; B41J 2/04503; B41J 2/04573; B41J 2/04588; B41J 2/04581

(57) ABSTRACT

A printing apparatus includes a print head that forms a dot on a medium at a timing defined by a position information signal, a position detection circuit that outputs a base position information signal corresponding to a change in a relative position between the medium and the print head, and a signal conversion circuit to which the base position information signal is input and which outputs the position information signal corresponding to the base position information signal, in which the signal conversion circuit acquires the base position information signal and a clock signal, and outputs the position information signal corresponding to a sum of at least one edge interval of the base position information signal and at least one pulse cycle of the clock signal.

The present application is based on, and claims priority from JP Application Serial Number 2025-056169, filed Mar. 28, 2025, the disclosure of which is hereby incorporated by reference herein in its entirety.

### BACKGROUND

### 1. Technical Field

The present disclosure relates to a printing apparatus.

### 2. Related Art

As described in JP-A-2022-038684, in a printing apparatus that forms an image on a medium, a technique is known that detects a position of the medium on which the image is formed or a position of the print head that forms the image on the medium, using an encoder, and controls the timing of image formation on the medium by the print head based on a detection result of the encoder.

However, from the viewpoint of improving timing accuracy of the image formation on the medium by the print head and improving the quality of the image formed on the medium, the technique disclosed in JP-A-2022-038684 is not sufficient, and there is room for further improvement.

### SUMMARY

According to an aspect of the present disclosure, there is provided a printing apparatus including a print head that forms a dot on a medium at a timing defined by a position information signal, a position detection circuit that outputs a base position information signal corresponding to a change in a relative position between the medium and the print head, and a signal conversion circuit to which the base position information signal is input and which outputs the position information signal corresponding to the base position information signal, in which the signal conversion circuit acquires the base position information signal and a clock signal, and outputs the position information signal corresponding to a sum of at least one edge interval of the base position information signal and at least one pulse cycle of the clock signal.

### BRIEF DESCRIPTION OF THE DRAWINGS

FIG. 1 is a diagram illustrating a schematic configuration of a printing apparatus.

FIG. 2 is a diagram illustrating a functional configuration of the printing apparatus.

FIG. 3 is a diagram illustrating a schematic configuration of a discharge portion.

FIG. 4 is a diagram illustrating an example of waveforms of drive signals.

FIG. 5 is a diagram illustrating a functional configuration of a drive signal selection circuit.

FIG. 6 is a diagram illustrating an example of content of decoding in a decoder.

FIG. 7 is a diagram illustrating a configuration of a selection circuit.

FIG. 8 is a diagram illustrating an operation of the drive signal selection circuit.

FIG. 9 is a diagram illustrating a configuration of a conversion circuit.

FIG. 10 is a diagram illustrating an example of a specific configuration of an edge detection circuit.

FIG. 11 is a diagram illustrating an example of a specific configuration of a combination circuit.

FIG. 12 is a diagram illustrating an example of a data structure stored in a storage circuit.

FIG. 13 is a diagram illustrating a specific example of a method for generating position information signals.

### DESCRIPTION OF EMBODIMENTS

Hereinafter, preferred embodiments of the present disclosure will be described with reference to the drawings. The drawings to be used are for convenience of description. In addition, the embodiments that will be described below do not inappropriately limit the content of the present disclosure described in the claims. In addition, not all of configurations that will be described below are necessarily essential requirements of the present disclosure.

### 1. Overview of Printing Apparatus

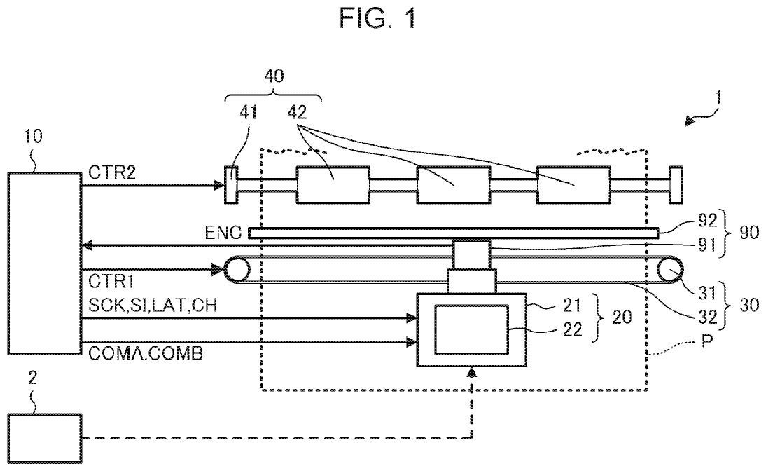

FIG. 1 is a diagram illustrating a schematic configuration of a printing apparatus 1. The printing apparatus 1 according to the present embodiment is a so-called serial-printing-type ink jet printer in which a carriage 21, on which a print head 22 is mounted, is moved along a scanning axis, a medium P, on which an image is formed, is transported in a transport direction intersecting the scanning axis, and the print head 22 mounted on the carriage 21 discharges ink to the transported medium P, thereby forming a desired image on the medium P. The printing apparatus 1 is not limited to the serial-printing-type ink jet printer, and may be a line-printing-type ink jet printer, a dot impact printer, or a laser printer. In addition, any configurations, such as printing paper including roll paper or sheet paper, a resin film, and fabrics, can be used as the medium P on which an image is formed in the printing apparatus 1.

As illustrated in FIG. 1, the printing apparatus 1 includes a control unit 10, a head unit 20, a moving unit 30, a transport unit 40, and an encoder unit 90.

Ink is supplied from an ink container 2 to the printing apparatus 1. A plurality of types of ink to be discharged to the medium P are stored in the ink container 2. Examples of the ink stored in the ink container 2 include inks of various colors such as black, cyan, magenta, yellow, red, and gray. Further, an ink cartridge, a bag-shaped ink pack made of a flexible film, an ink tank that can be refilled with ink, or the like can be used as the ink container 2.

The control unit 10 includes, for example, a processing circuit, such as a central processing unit (CPU) or a field programmable gate array (FPGA), and a storage circuit, such as a semiconductor memory, generates signals for controlling each element of the printing apparatus 1 based on image data input from the outside of the printing apparatus 1 and a base position information signal ENC input from the encoder unit 90, which will be described below, and outputs the signals to the corresponding configurations.

The head unit 20 includes the carriage 21 and the print head 22. The print head 22 is mounted on the carriage 21. In addition, the carriage 21 is fixed to an endless belt 32 included in the moving unit 30 which will be described below. A clock signal SCK, a print data signal SI, a latch signal LAT, and a change signal CH, which are output by the control unit 10 to control the discharge of the ink, and drive signals COMA and COMB for driving the print head 22 such that the ink is discharged are input to the print head 22. The print head 22 discharges the ink supplied from the ink container 2 to the medium P based on the input clock signal SCK, print data signal SI, latch signal LAT, change signal CH, and drive signals COMA and COMB.

The moving unit 30 includes a carriage motor 31 and the endless belt 32. The carriage motor 31 is driven based on a control signal CTR1 input from the control unit 10. The endless belt 32 is rotated according to the driving of the carriage motor 31. As the endless belt 32 is rotated, the carriage 21 fixed to the endless belt 32 is moved along the scanning axis. That is, the print head 22 is moved along the scanning axis.

The transport unit 40 includes a transport motor 41 and a transport roller 42. The transport motor 41 is driven based on a control signal CTR2 input from the control unit 10. The transport roller 42 is rotated according to the driving of the transport motor 41. As the transport roller 42 is rotated, the medium P is transported along the transport direction.

The encoder unit 90 has a detection sensor 91 and a linear scale 92. The encoder unit 90 generates the base position information signal ENC corresponding to a change in the relative position between the medium P and the print head 22 which is the amount of movement of the print head 22 along the scanning axis and outputs the base position information signal ENC.

The linear scale 92 includes a plurality of scales that extend along the scanning axis and are formed at equal intervals along the scanning axis. The detection sensor 91 is mounted on the carriage 21 together with the print head 22 in a state in which the detection sensor 91 faces at least one of the plurality of scales included in the linear scale 92. The detection sensor 91 detects physical quantities corresponding to the positions of the plurality of scales included in the linear scale 92 and outputs the base position information signal ENC corresponding to the detected physical quantities. In the printing apparatus 1 including the encoder unit 90, when the carriage 21 is moved along the scanning axis, the position of the scale located to face the detection sensor 91 changes, and the physical quantity detected by the detection sensor 91 changes. The detection sensor 91 included in the encoder unit 90 detects the physical quantity that changes with the movement of the carriage 21 along the scanning axis and outputs, from the encoder unit 90, a signal corresponding to the detected physical quantity as the base position information signal ENC corresponding to a change in the relative position between the medium P and the print head 22 which is the amount of movement of the print head 22 along the scanning axis.

As such an encoder unit 90, an optical encoder or a magnetic encoder may be used.

When the optical encoder is used as the encoder unit 90, the linear scale 92 has a plurality of slits arranged side by side at equal intervals along the scanning axis as the plurality of scales, and the detection sensor 91 has a light receiving element that detects light transmitted through the slit as the physical quantity corresponding to the position of the scale. When the carriage 21 on which the print head 22 is mounted is moved along the scanning axis, the light receiving element included in the detection sensor 91 is supplied with pulsed light as the light is alternately repeatedly blocked and transmitted by the plurality of slits included in the linear scale 92. Therefore, the light receiving element included in the detection sensor 91 detects the pulsed light corresponding to the amount of movement of the print head 22 and outputs a pulse signal corresponding to the detected pulsed light. The detection sensor 91 outputs the pulse signal output by the light receiving element to the control unit 10 as the base position information signal ENC. At this time, the print head 22 is moved along the scanning axis by a distance that is defined by the resolution of the optical encoder as the encoder unit 90 in the cycle of the pulse signal output as the base position information signal ENC. That is, the amount of movement of the print head 22 along the scanning axis during a predetermined period is defined by the product of the distance defined by the resolution of the optical encoder as the encoder unit 90 and the number of pulse signals included in the base position information signal ENC during the predetermined period.

When the optical encoder as described above is used as the encoder unit 90, the base position information signal ENC corresponding to the light transmitted through the plurality of slits included in the linear scale 92 is output, and thus the encoder unit 90 is less affected by noise or the like and can detect the scanning position of the carriage 21 and the print head 22 with high accuracy.

In addition, when the magnetic encoder is used as the encoder unit 90, the linear scale 92 has, as the plurality of scales, a plurality of magnetic poles arranged side by side at equal intervals such that S poles and N poles alternate along the scanning axis, and the detection sensor 91 has a Hall element that detects the strength of the magnetic field generated by the magnetic poles as the physical quantity corresponding to the position of the scale. When the carriage 21 on which the print head 22 is mounted is moved along the scanning axis, the magnetic pole located to face the Hall element of the detection sensor 91 alternately changes between the S pole and the N pole. As a result, the strength of the magnetic field detected by the Hall element included in the detection sensor 91 changes, and the Hall element included in the detection sensor 91 outputs an analog voltage signal whose voltage value changes according to the change in the strength of the magnetic field. The detection sensor 91 detects the phase of the analog voltage signal output by the Hall element, generates a pulse signal whose logic level changes according to the detected phase, and outputs the pulse signal as the base position information signal ENC to the control unit 10. At this time, the print head 22 is moved along the scanning axis by a distance that is defined by the resolution of the magnetic encoder as the encoder unit 90 in the cycle of the pulse signal output as the base position information signal ENC. That is, the amount of movement of the print head 22 along the scanning axis during a predetermined period is defined by the product of the distance defined by the resolution of the magnetic encoder as the encoder unit 90 and the number of pulse signals included in the base position information signal ENC during the predetermined period.

When the magnetic encoder as described above is used as the encoder unit 90, the encoder unit 90 can stably detect the scanning position of the carriage 21 and the print head 22, regardless of a shock or a floating substance, even when used in an environment in which the shock is likely to occur or in an environment in which a large number of floating substances, such as dust and mist, are present.

Here, in the printing apparatus 1 according to the present embodiment, a case where the linear encoder is used as the encoder unit 90 will be described as an example. However, the encoder unit 90 may be a rotary encoder. In this case, the encoder unit 90 may detect, for example, a rotation angle of the carriage motor 31 and calculate the scanning position of the print head 22 mounted on the carriage 21 from the detected rotation angle. In addition, the printing apparatus 1 may include an encoder for detecting the transport position of the medium P transported by the transport unit 40, instead of or in addition to the encoder unit 90 that detects the scanning position of the print head 22 which is the amount of movement of the print head 22. At this time, the encoder that detects the transport position of the medium P may be a magnetic encoder or an optical encoder. In addition, the encoder that detects the transport position of the medium P may be a linear encoder or a rotary encoder.

As described above, the printing apparatus 1 according to the present embodiment discharges ink from the print head 22 mounted on the carriage 21 in operative association with the transport of the medium P by the transport unit 40 and the reciprocating movement of the carriage 21 by the moving unit 30. As a result, the ink lands on any position on the surface of the medium P, and a desired image is formed on the medium P.

### 2. Functional Configuration of Printing Apparatus

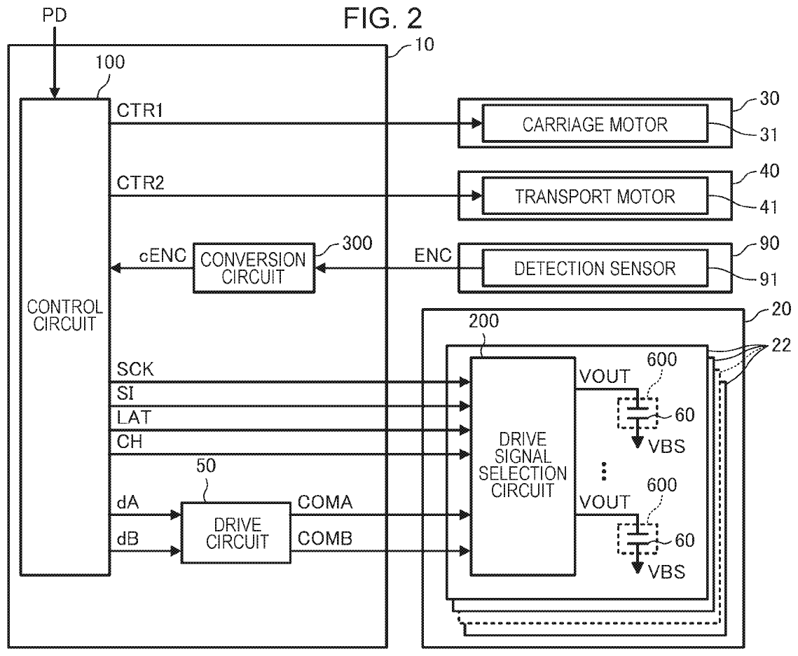

FIG. 2 is a diagram illustrating a functional configuration of the printing apparatus 1. As illustrated in FIG. 2, the printing apparatus 1 includes the control unit 10, the head unit 20, the moving unit 30, the transport unit 40, and the encoder unit 90. The control unit 10, the head unit 20, the moving unit 30, the transport unit 40, and the encoder unit 90 are electrically coupled to each other by cables (not illustrated) having sliding properties such as flexible flat cables.

The control unit 10 includes a control circuit 100, a drive circuit 50, and a conversion circuit 300.

The base position information signal ENC output by the encoder unit 90 is input to the conversion circuit 300. The conversion circuit 300 converts the input base position information signal ENC to generate a position information signal cENC that is the position information of the carriage 21, on which the print head 22 is mounted, and corresponds to the scanning position of the print head 22, and outputs the position information signal cENC to the control circuit 100. In addition, the conversion circuit 300 will be described in detail below.

The control circuit 100 receives an image information signal IMG including image data to be formed on the medium P from an external device, such as a host computer, and the position information signal cENC output by the conversion circuit 300. Then, the control circuit 100 generates various control signals for controlling each portion of the printing apparatus 1 based on the image information signal IMG and the position information signal cENC and outputs the control signals to the corresponding configurations.

Specifically, the control circuit 100 acquires the position information of the carriage 21 based on the position information signal cENC and generates the control signal CTR1 corresponding to the acquired position information of the carriage 21. Then, the control circuit 100 outputs the generated control signal CTR1 to the carriage motor 31 included in the moving unit 30. Then, the carriage motor 31 is driven, and the movement of the carriage 21 along the scanning axis is controlled. Further, the control circuit 100 generates the control signal CTR2 at the timing defined by the position information signal cENC and outputs the control signal CTR2 to the transport motor 41 included in the transport unit 40. Then, the transport motor 41 is driven, and the transport of the medium P along the transport direction is controlled. That is, the control circuit 100 controls the relative position between the print head 22 mounted on the carriage 21 and the medium P on which an image is formed, based on the position information signal cENC.

Further, the control circuit 100 generates base drive signals dA and dB at the timing defined by the position information signal cENC and outputs the base drive signals dA and dB to the drive circuit 50. The drive circuit 50 generates the drive signals COMA and COMB based on the input base drive signals dA and dB and outputs the drive signals COMA and COMB to the head unit 20. Specifically, the drive circuit 50 converts the input base drive signal dA, which is a digital signal, into an analog signal, amplifies the converted analog signal using Class D amplification to generate the drive signal COMA, and outputs the drive signal COMA to the head unit 20. The drive circuit 50 converts the input base drive signal dB, which is a digital signal, into an analog signal, amplifies the converted analog signal using Class D amplification to generate the drive signal COMB, and outputs the drive signal COMB to the head unit 20. That is, the drive circuit 50 includes an amplifier circuit that outputs the drive signal COMA based on the base drive signal dA and an amplifier circuit that outputs the drive signal COMB based on the base drive signal dB at the timing defined by the position information signal cENC.

In addition, the control circuit 100 generates the print data signal SI for controlling the discharge of the ink from the print head 22 according to the image information signal IMG and generates the latch signal LAT and the change signal CH for controlling the discharge timing of the ink from the print head 22 based on the position information signal cENC. Then, the control circuit 100 outputs the generated print data signal SI, latch signal LAT, and change signal CH, and the clock signal SCK propagating the print data signal SI to the head unit 20. In other words, the control circuit 100 generates the clock signal SCK, the print data signal SI, the latch signal LAT, and the change signal CH for controlling the discharge of the ink from the print head 22 based on the image information signal IMG and the position information signal cENC and outputs the generated signals to the head unit 20.

The head unit 20 has a plurality of print heads 22. Each of the plurality of print heads 22 includes a drive signal selection circuit 200 and a plurality of discharge portions 600. The clock signal SCK, the print data signal SI, the latch signal LAT, the change signal CH, and the drive signals COMA and COMB are input to the drive signal selection circuit 200. The drive signal selection circuit 200 selects or deselects the waveforms of the drive signals COMA and COMB according to the print data signal SI synchronized with the clock signal SCK at the timing defined by the latch signal LAT and the change signal CH supplied from the control circuit 100 to generate drive signals VOUT corresponding to each of the plurality of discharge portions 600 and outputs the drive signals VOUT to the corresponding discharge portions 600.

Each of the plurality of discharge portions 600 includes a piezoelectric element 60. The drive signal VOUT output by the drive signal selection circuit 200 is supplied to one end of the piezoelectric element 60. In addition, a reference voltage signal VBS is supplied to the other end of the piezoelectric element 60. Then, the piezoelectric element 60 is driven according to a potential difference between the drive signal VOUT and the reference voltage signal VBS. The amount of ink corresponding to the driving of the piezoelectric element 60 is discharged from the discharge portion 600. Here, the voltage value of the reference voltage signal VBS supplied to the other end of the piezoelectric element 60 is, for example, a constant voltage value of 5.5 V or 6 V. The voltage value may be supplied from a constant voltage circuit (not illustrated) or may be supplied from the drive circuit 50. In addition, the voltage value of the reference voltage signal VBS may be a ground potential.

As described above, the printing apparatus 1 of the present embodiment includes the print head 22 that discharges ink to the medium P to form dots on the medium P, the encoder unit 90 that outputs the base position information signal ENC, which is the scanning position of the print head 22 mounted on the carriage 21 and corresponds to a change in the relative position between the medium P and the print head 22, and the conversion circuit 300 that receives the base position information signal ENC and outputs the position information signal cENC corresponding to the base position information signal ENC.

Further, when including an encoder that detects the transport position of the medium P, the printing apparatus 1 may have a configuration that corresponds to the conversion circuit 300 corresponding to the encoder.

### 3. Configuration of Head Unit

### 3.1 Functional Configuration of Head Unit

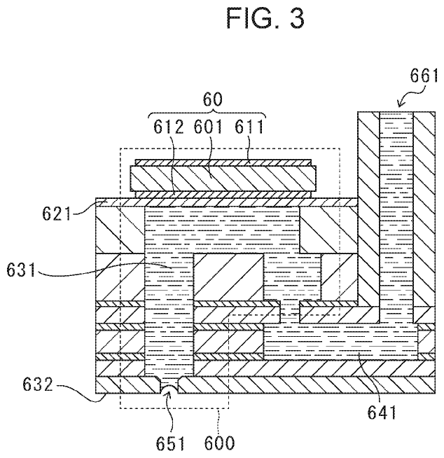

Next, the head unit 20 will be described. FIG. 3 is a diagram illustrating a schematic configuration of one of the plurality of discharge portions 600 included in the print head 22. As illustrated in FIG. 3, the discharge portion 600 includes the piezoelectric element 60, a diaphragm 621, a cavity 631, and a nozzle 651.

The cavity 631 is filled with ink supplied from a reservoir 641. In addition, ink is introduced into the reservoir 641 from the ink container 2 via an ink tube (not illustrated) and a supply port 661. That is, the cavity 631 is filled with the ink supplied from the ink container 2. The diaphragm 621 is displaced by the driving of the piezoelectric element 60 provided on an upper surface in FIG. 3. Then, the internal volume of the cavity 631 is increased or decreased with the displacement of the diaphragm 621. The nozzle 651 is an opening portion that is provided in a nozzle plate 632 and communicates with the cavity 631. Then, the internal volume of the cavity 631 changes with the displacement of the diaphragm 621. As a result, the amount of ink corresponding to the change in the internal volume of the cavity 631 is discharged from the nozzle 651. The piezoelectric element 60 includes a piezoelectric body 601 and a pair of electrodes 611 and 612. The pair of electrodes 611 and 612 are provided such that the piezoelectric body 601 is interposed therebetween. The piezoelectric body 601 bends in the vertical direction together with the diaphragm 621 according to a potential difference between the voltages supplied to the electrodes 611 and 612.

In the discharge portion 600 configured as described above, the piezoelectric element 60 bends upward, and the diaphragm 621 is displaced upward, resulting in an increase in the internal volume of the cavity 631. As a result, the ink stored in the reservoir 641 is drawn into the cavity 631. On the other hand, when the piezoelectric element 60 bends downward, the diaphragm 621 is displaced downward, resulting in a decrease in the internal volume of the cavity 631. As a result, the amount of ink corresponding to the degree of decrease is discharged from the nozzle 651. In addition, the piezoelectric element 60 included in the discharge portion 600 is not limited to the bending vibration structure illustrated in FIG. 3 and may have, for example, a longitudinal vibration structure.

### 3.2 Configuration and Operation of Drive Signal Selection Circuit

Next, the configuration and operation of the drive signal selection circuit 200 will be described. As described above, the drive signal selection circuit 200 selects or deselects the waveforms of the drive signals COMA and COMB according to the print data signal SI input in synchronization with the clock signal SCK at the timing defined by the latch signal LAT and the change signal CH to generate the drive signal VOUT and supplies the drive signal VOUT to the corresponding discharge portion 600. In describing the configuration and operation of the drive signal selection circuit 200, first, an example of the waveforms of the drive signals COMA and COMB output by the drive circuit 50 will be described.

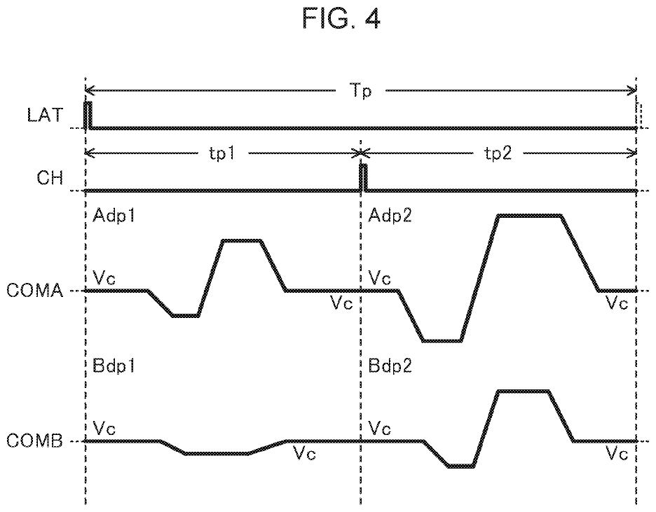

FIG. 4 is a diagram illustrating an example of the waveforms of the drive signals COMA and COMB. As illustrated in FIG. 4, the drive signal COMA has a signal waveform in which a trapezoidal waveform Adp1 disposed during a period tp1 from a rising edge of the latch signal LAT to a rising edge of the change signal CH and a trapezoidal waveform Adp2 disposed during a period tp2 from the rising edge of the change signal CH to the rising edge of the latch signal LAT are continuous. The trapezoidal waveform Adp1 is a signal waveform for driving the piezoelectric element 60 such that a predetermined amount of ink is discharged from the nozzle 651, and the trapezoidal waveform Adp2 is a signal waveform for driving the piezoelectric element 60 such that an amount of ink larger than the predetermined amount is discharged from the nozzle 651.

The drive signal COMB has a signal waveform in which a trapezoidal waveform Bdp1 disposed during the period tp1 and a trapezoidal waveform Bdp2 disposed during the period tp2 are continuous. The trapezoidal waveform Bdp1 is a signal waveform for driving the piezoelectric element 60 such that no ink is discharged from the nozzle 651 and is a signal waveform for driving the piezoelectric element 60 such that the ink in the vicinity of the opening portion of the corresponding nozzle 651 vibrates. As a result, the concern that the viscosity of the ink in the vicinity of the opening portion of the corresponding nozzle 651 may increase is reduced. The trapezoidal waveform Bdp2 is a signal waveform for driving the piezoelectric element 60 such that a predetermined amount of ink is discharged from the nozzle 651, similarly to the trapezoidal waveform Adp1.

Here, in the following description, a predetermined amount of ink discharged from the nozzle 651 when the piezoelectric element 60 is driven by the trapezoidal waveforms Adp1 and Bdp2 may be referred to as a small amount of ink, and the amount of ink discharged from the nozzle 651 when the piezoelectric element 60 is driven by the trapezoidal waveform Adp2, which is larger than the predetermined amount of ink, may be referred to as a medium amount of ink. In addition, the operation that drives the piezoelectric element 60 with the trapezoidal waveform Bdp1 such that no ink is discharged from the nozzle 651 and that vibrates the ink in the vicinity of the opening portion of the corresponding nozzle 651 to reduce the concern that the viscosity of the ink in the vicinity of the opening portion of the nozzle 651 may increase is referred to as a micro-vibration BSD. Further, all of the voltage values of the trapezoidal waveforms Adp1, Adp2, Bdp1, and Bdp2 at the start timing and the end timing are a voltage Vc which is a common voltage. In other words, each of the trapezoidal waveforms Adp1, Adp2, Bdp1, and Bdp2 is a waveform that starts at the voltage Vc and ends at the voltage Vc. A cycle Tp that is composed of the periods tp1 and tp2 and defined by the latch signal LAT corresponds to a printing cycle for forming desired dots on the medium P. In other words, the print head 22 forms desired dots on the medium P at the timing defined by the latch signal LAT in the cycle Tp defined by the latch signal LAT.

In addition, FIG. 4 illustrates a case where the trapezoidal waveform Adp1 and the trapezoidal waveform Bdp2 are the same signal waveform. However, the trapezoidal waveform Adp1 and the trapezoidal waveform Bdp2 may be different signal waveforms. Further, the case where a small amount of ink is discharged from the corresponding nozzle both when the trapezoidal waveform Adp1 is supplied to the discharge portion 600 and when the trapezoidal waveform Bdp1 is supplied to the discharge portion 600 was described. However, different amounts of ink may be discharged. That is, the waveforms of the drive signals COMA and COMB are not limited to the signal waveforms illustrated in FIG. 4, and various signal waveforms may be combined according to the moving speed of the carriage 21 on which the print head 22 is mounted, the properties of the ink supplied to the print head 22, the material of the medium P on which the ink discharged from the print head 22 lands, and the like.

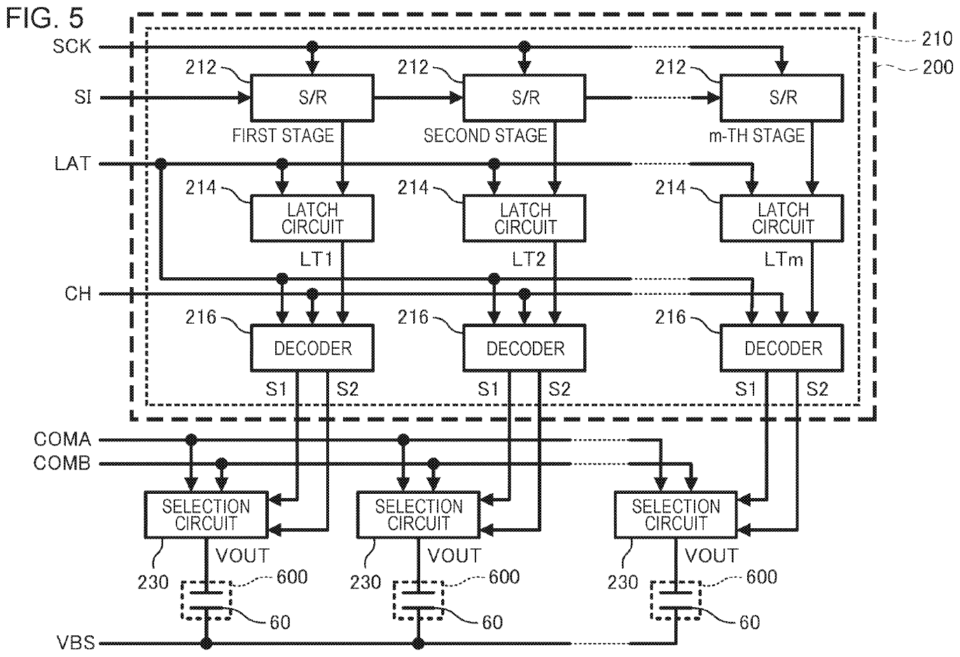

FIG. 5 is a diagram illustrating a functional configuration of the drive signal selection circuit 200. As illustrated in FIG. 5, the drive signal selection circuit 200 includes a selection control circuit 210 and a plurality of selection circuits 230.

The print data signal SI, the latch signal LAT, the change signal CH, and the clock signal SCK are input to the selection control circuit 210. Further, the selection control circuit 210 includes m (m is a natural number equal to or greater than 1) sets of shift registers (S/R) 212, latch circuits 214, and decoders 216 that correspond to m discharge portions 600, respectively.

The print data signal SI is a signal synchronized with the clock signal SCK and is a signal having a total of 2 m bits or more including 2-bit print data [SIH, SIL] for selecting any one of a large dot LD, a medium dot MD, a small dot SD, and the micro-vibration BSD for each of the m discharge portions 600. The input print data signal SI is held in the shift register 212 for each print data item [SIH, SIL] corresponding to 2 bits included in the print data signal SI, corresponding to the m discharge portions 600. Specifically, in the selection control circuit 210, the m-stage shift registers 212 corresponding to the m discharge portions 600 are cascaded together, and the serially input print data signal SI is sequentially transferred to the subsequent stages according to the clock signal SCK. Further, in FIG. 5, in order to distinguish the m-stage shift registers 212, the m-stage shift registers 212 are denoted as registers in a first stage, a second stage, . . . , and an m-th stage in order from the upstream where the print data signal SI is input.

Each of the m latch circuits 214 latches the 2-bit print data [SIH, SIL] held by each of the m shift registers 212 at the rising edge of the latch signal LAT and outputs the latched print data [SIH, SIL] to the decoder 216.

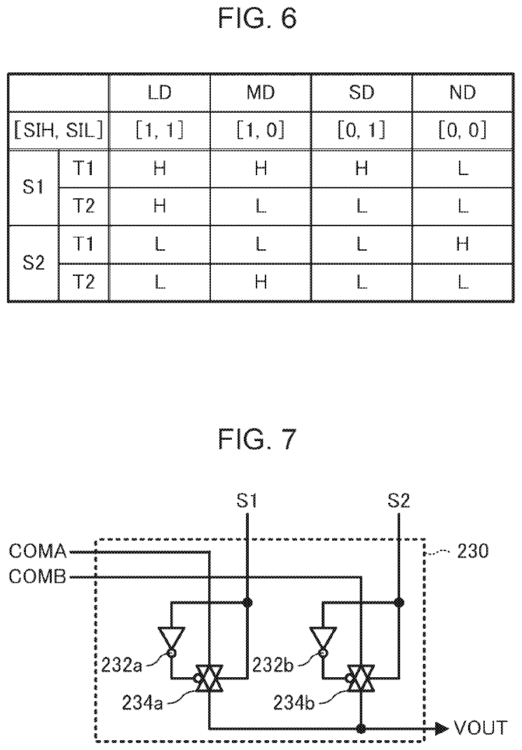

The decoder 216 decodes the 2-bit print data [SIH, SIL] latched by the latch circuit 214 to generate selection signals S1 and S2 and outputs the selection signals S1 and S2. FIG. 6 is a diagram illustrating an example of the content of decoding in the decoder 216. As illustrated in FIG. 6, for example, when the input 2-bit print data [SIH, SIL] is [1, 0], the decoder 216 outputs the selection signal S1 to the selection circuit 230 as H and L levels during the periods tp1 and tp2, respectively, and outputs the selection signal S2 to the selection circuit 230 as L and H levels during the periods tp1 and tp2, respectively.

Returning to FIG. 5, the selection circuit 230 is provided corresponding to each of the discharge portions 600. That is, the number of selection circuits 230 included in the drive signal selection circuit 200 is m, which is the same as the total number of discharge portions 600. FIG. 7 is a diagram illustrating a configuration of the selection circuit 230 corresponding to one discharge portion 600. As illustrated in FIG. 7, the selection circuit 230 has inverters 232a and 232b, which are NOT circuits, and transfer gates 234a and 234b. The selection signal S1 is input to a positive control terminal, which is not marked with a circle, in the transfer gate 234a, is logically inverted by the inverter 232a, and is input to a negative control terminal, which is marked with a circle, in the transfer gate 234a. In addition, the selection signal S2 is input to a positive control terminal, which is not marked with a circle, in the transfer gate 234b, is logically inverted by the inverter 232b, and is input to a negative control terminal, which is marked with a circle, in the transfer gate 234b. Moreover, the drive signal COMA is supplied to an input terminal of the transfer gate 234a, and the drive signal COMB is supplied to an input terminal of the transfer gate 234b. Then, the output terminals of the transfer gates 234a and 234b are commonly coupled. The signal at the commonly coupled output terminals of the transfer gates 234a and 234b is output as the drive signal VOUT.

Specifically, in the transfer gate 234a, the input terminal and the output terminal are electrically coupled when the selection signal S1 is at an H level and are not electrically coupled when the selection signal S1 is at an L level. In addition, in the transfer gate 234b, the input terminal and the output terminal are electrically coupled when the selection signal S2 is at an H level and are not electrically coupled when the selection signal S2 is at an L level. That is, the selection circuit 230 switches the on and off states of the transfer gates 234a and 234b based on the selection signals S1 and S2 to select the waveforms of the drive signals COMA and COMB, thereby generating the drive signal VOUT.

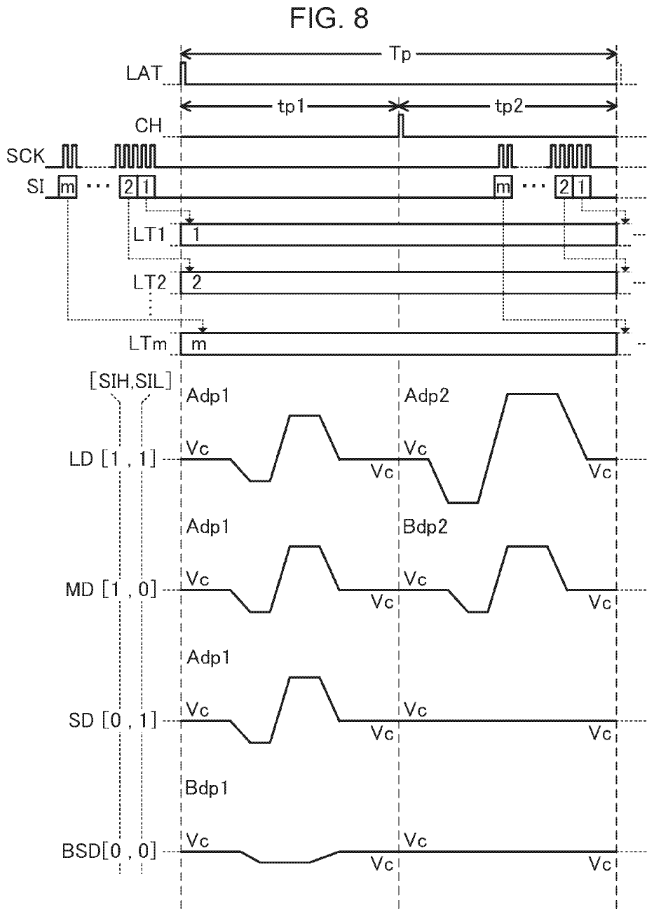

The operation of the drive signal selection circuit 200 will be described with reference to FIG. 8. FIG. 8 is a diagram illustrating the operation of the drive signal selection circuit 200. First, the print data signal SI is serially input to the drive signal selection circuit 200 in synchronization with the clock signal SCK. The print data signal SI input to the drive signal selection circuit 200 is sequentially transferred to the shift register 212 in synchronization with the clock signal SCK. Then, the supply of the clock signal SCK is stopped, and the 2-bit print data [SIH, SIL] corresponding to each of the discharge portions 600 is held in each shift register 212.

Then, when the latch signal LAT rises, the latch circuits 214 simultaneously latch the 2-bit print data [SIH, SIL] held in the shift registers 212 and output the latched print data to the decoders 216. In addition, LT1, LT2, . . . , and LTm illustrated in FIG. 8 indicate the 2-bit print data [SIH, SIL] latched by the latch circuits 214 corresponding to the shift registers 212 in the first, second, . . . , m-th stages.

The decoder 216 decodes the latched 2-bit print data [SIH, SIL] according to the content illustrated in FIG. 6 to generate the selection signals S1 and S2 corresponding to the sizes of the dots defined by the print data [SIH, SIL] and outputs the selection signals S1 and S2 to the selection circuit 230.

Specifically, when the input print data [SIH, SIL] is [1, 1], the decoder 216 generates the selection signal S1 at H and H levels and the selection signal S2 at L and L levels during the periods tp1 and tp2, respectively. Then, the selection circuit 230 selects the trapezoidal waveform Adp1 during the period tp1 and selects the trapezoidal waveform Adp2 during the period tp2. That is, the drive signal selection circuit 200 outputs the drive signal VOUT corresponding to the large dot LD illustrated in FIG. 8. At this time, a small amount of ink is discharged during the period tp1, and a medium amount of ink is discharged during the period tp2 from the nozzle 651 included in the discharge portion 600. The small amount of ink and the medium amount of ink land on the medium P and are combined to form the large dot LD on the medium P in the cycle Tp.

Further, when the input print data [SIH, SIL] is [1, 0], the decoder 216 generates the selection signal S1 at H and L levels and the selection signal S2 at L and H levels during the periods tp1 and tp2, respectively. Then, the selection circuit 230 selects the trapezoidal waveform Adp1 during the period tp1 and selects the trapezoidal waveform Bdp2 during the period tp2. That is, the drive signal selection circuit 200 outputs the drive signal VOUT corresponding to the medium dot MD illustrated in FIG. 8. At this time, a small amount of ink is discharged during the period tp1, and a small amount of ink is discharged during the period tp2 from the nozzle 651 included in the discharge portion 600. The small amount of ink lands on the medium P in two separate stages and is combined to form the medium dot MD on the medium P in the cycle Tp.

Further, when the input print data [SIH, SIL] is [0, 1], the decoder 216 generates the selection signal S1 at H and L levels and the selection signal S2 at L and L levels during the periods tp1 and tp2, respectively. Then, the selection circuit 230 selects the trapezoidal waveform Adp1 during the period tp1 and selects neither of the trapezoidal waveforms Adp2 and Bdp2 during the period tp2. That is, the drive signal selection circuit 200 outputs the drive signal VOUT corresponding to the small dot SD illustrated in FIG. 8. At this time, a small amount of ink is discharged during the period tp1, and no ink is discharged during the period tp2 from the nozzle 651 included in the discharge portion 600. The small amount of ink lands on the medium P, and the small dot SD is formed on the medium P in the cycle Tp.

Further, when the input print data [SIH, SIL] is [0, 0], the decoder 216 generates the selection signal S1 at L and L levels and the selection signal S2 at H and L levels during the periods tp1 and tp2, respectively. Therefore, the selection circuit 230 selects the trapezoidal waveform Bdp1 during the period tp1 and selects neither of the trapezoidal waveforms Adp2 and Bdp2 during the period tp2. That is, the drive signal selection circuit 200 outputs the drive signal VOUT corresponding to the micro-vibration BSD illustrated in FIG. 8. At this time, during the period tp1, no ink is discharged from the corresponding nozzle 651, and the micro-vibration BSD for vibrating the ink in the vicinity of the opening portion of the nozzle 651 is executed. No ink is discharged during the period tp2. That is, in the cycle Tp, no dots are formed on the medium P, and the micro-vibration BSD is executed.

As described above, the drive signal selection circuit 200 selects or deselects the waveforms of the drive signals COMA and COMB according to the print data signal SI input in synchronization with the clock signal SCK at the timing defined by the latch signal LAT and the change signal CH to generate the drive signal VOUT, and supplies the drive signal VOUT to the corresponding discharge portion 600. Here, the control circuit 100 outputs the latch signal LAT defining the cycle Tp based on the position information signal cENC obtained by converting the base position information signal ENC output by the encoder unit 90. Therefore, it can be said that the drive signal selection circuit 200 selects or deselects the waveforms of the drive signals COMA and COMB according to the print data signal SI input in synchronization with the clock signal SCK at the timing defined by the position information signal cENC obtained by converting the base position information signal ENC to generate the drive signal VOUT, and supplies the drive signal VOUT to the corresponding discharge portion 600. In other words, the print head 22 forms dots on the medium P at the timing defined by the position information signal cENC obtained by converting the base position information signal ENC, which is the timing defined by the latch signal LAT.

### 4. Configuration and Operation of Conversion Circuit

As described above, in the printing apparatus 1 according to the present embodiment, the control circuit 100 detects the scanning position of the print head 22 mounted on the carriage 21 according to the position information signal cENC based on the base position information signal ENC output by the encoder unit 90. Then, the control circuit 100 generates the latch signal LAT defining the cycle Tp for forming a desired dot on the medium P based on the detection result of the position information signal cENC and outputs the latch signal LAT to the print head 22. Therefore, the print head 22 discharges ink to the medium P at the timing corresponding to the relative position between the medium P and the print head 22 which is the timing corresponding to the scanning position of the print head 22. As a result, the ink lands at a desired position on the medium P, and a dot is formed at a desired position on the medium P.

Here, when the control circuit 100 directly generates the latch signal LAT defining the cycle Tp from the base position information signal ENC output by the encoder unit 90, the length of the cycle Tp defined by the latch signal LAT may vary. As a result, the amount of movement of the print head 22 in the cycle Tp may vary. That is, when the control circuit 100 directly generates the latch signal LAT from the base position information signal ENC output by the encoder unit 90, a variation in the scanning position of the print head 22 for each cycle Tp may occur. When the variation in the scanning position of the print head 22 for each cycle Tp occurs, a variation in the landing position of the ink on the medium P also occurs. As a result, the quality of the image formed on the medium P deteriorates.

Specifically, the amount of movement of the print head 22 for each cycle of the pulse signal included in the base position information signal ENC output by the encoder unit 90 is defined by the resolution of the encoder unit 90. In contrast, the ideal amount of movement of the print head 22 in an ideal cycle Tp in which the print head 22 discharges ink to the medium P is defined by the resolution of the image formed on the medium P by the printing apparatus 1. Therefore, the ideal amount of movement of the print head 22 in the ideal cycle Tp may not be an integer multiple of the amount of movement of the print head 22 in the cycle of the pulse signal included in the base position information signal ENC, depending on the resolution of the image formed on the medium P by the printing apparatus 1. Therefore, the length of the ideal cycle Tp may not be an integer multiple of the length of the cycle of the pulse signal included in the base position information signal ENC. That is, an error may occur between the length of the cycle Tp directly generated from the cycle of the pulse signal included in the base position information signal ENC and the length of the ideal cycle Tp, depending on the resolution of the image formed on the medium P by the printing apparatus 1. Therefore, an error also occurs between the amount of movement of the print head 22 in the cycle Tp directly generated from the cycle of the pulse signal included in the base position information signal ENC and the scanning position, and the ideal amount of movement of the print head 22 in the ideal cycle Tp and the ideal scanning position, and an error also occurs between the landing position of the ink discharged from the print head 22 in the cycle Tp directly generated from the cycle of the pulse signal included in the base position information signal ENC on the medium P and the ideal landing position of the ink discharged from the print head 22 in the ideal cycle Tp on the medium P. As a result, when the control circuit 100 directly generates the latch signal LAT defining the cycle Tp from the base position information signal ENC output by the encoder unit 90, there is a concern that the quality of the image formed on the medium P may deteriorate.

Here, the resolution of the printing apparatus 1 is generally defined by an “inch unit system” based on inches which is a unit system conforming to the Imperial system which is called dots per inch (dpi). In contrast, the resolution of the encoder unit 90 is generally defined by the SI unit system conforming to the metric system, for example, a “millimeter unit system” based on μm or mm. That is, in general, the unit that defines the resolution of the printing apparatus 1 is different from the unit that defines the resolution of the encoder unit 90. In the printing apparatus 1 that operates in different unit systems, there is an increased concern that the ideal amount of movement of the print head 22 in the ideal cycle Tp may not be an integer multiple of the amount of movement of the print head 22 in the cycle of the pulse signal included in the base position information signal ENC. For this reason, in the printing apparatus 1, there is an increased concern that the length of the ideal cycle Tp may not be an integer multiple of the length of the cycle of the pulse signal included in the base position information signal ENC. As a result, there is an increased concern that the quality of the image formed on the medium P may deteriorate due to this problem.

Specifically, for example, when the resolution of the printing apparatus 1 is 600 dpi and the resolution of the encoder unit 90 is 1 μm, the ideal amount of movement of the print head 22 in the ideal cycle Tp is 42.333 . . . μm. In contrast, the amount of movement of the print head 22 that can be controlled based on the resolution of the encoder unit 90 is 42 μm or 43 μm. That is, an error corresponding to 0.333 . . . μm occurs between the length of the cycle Tp directly generated from the cycle of the pulse signal included in the base position information signal ENC and the length of the ideal cycle Tp. Therefore, an error of 0.333 . . . μm also occurs in the landing position of the ink on the medium P.

In order to address the above problem, the printing apparatus 1 according to the present embodiment includes the conversion circuit 300 that converts the base position information signal ENC into the position information signal cENC including a pulse signal with a cycle that is substantially an integer fraction of the ideal cycle Tp based on the cycle of the pulse signal included in the base position information signal ENC output by the encoder unit 90. The control circuit 100 outputs the latch signal that defines the cycle Tp based on the position information signal cENC output by the conversion circuit 300. Therefore, the concern that an error may occur between the amount of movement and scanning position of the print head 22 in the cycle Tp defined by the latch signal LAT output by the control circuit 100 and the ideal amount of movement and ideal scanning position of the print head 22 in the ideal cycle Tp is reduced. As a result, the concern that an error may occur between the ideal landing position of the ink, which is discharged from the print head 22 in the ideal cycle Tp, on the medium P and the landing position of the ink, which is discharged from the print head 22 in the cycle Tp defined by the latch signal LAT generated based on the cycle of the pulse signal included in the position information signal cENC, on the medium P is reduced.

A specific example of the configuration and operation of the conversion circuit 300 will be described. Here, the following description assumes that the encoder unit 90 includes a two-phase-output-type encoder which is an incremental encoder and outputs an A-phase signal and a B-phase signal that is shifted by 90 degrees in phase with respect to the A-phase signal. Further, in the following description, the A-phase signal in the base position information signal ENC output by the encoder unit 90 may be referred to as a base position information signal ENa, and the B-phase signal in the base position information signal ENC output by the encoder unit 90 may be referred to as a base position information signal ENb. Here, a phase shift relationship between the phase of the A-phase base position information signal ENa and the phase of the B-phase base position information signal ENb changes depending on the movement direction of the carriage 21 along the scanning axis. In the present embodiment, the following description assumes that, when the carriage 21 is moved from one side to the other side along the scanning axis, the phase of the B-phase base position information signal ENb lags the phase of the A-phase base position information signal ENa by 90 degrees, and when the carriage 21 is moved from the other side to one side along the scanning axis, the phase of the B-phase base position information signal ENb leads the phase of the A-phase base position information signal ENa by 90 degrees. In addition, the encoder unit 90 is not limited to the incremental type and may be an absolute type. Further, the encoder unit 90 is not limited to the two-phase output type and may be a single-phase output type or a three-phase output type.

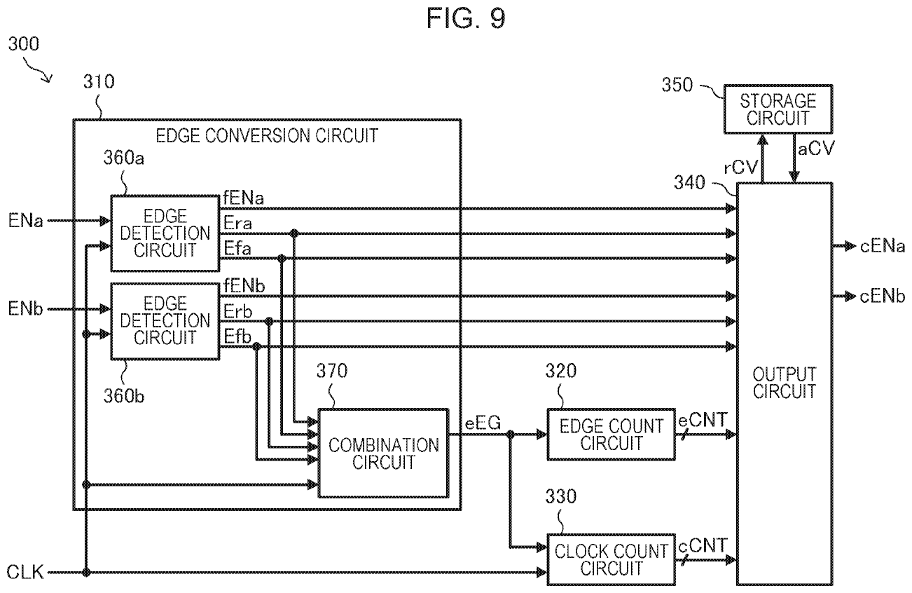

FIG. 9 is a diagram illustrating a configuration of the conversion circuit 300. As illustrated in FIG. 9, the base position information signals ENa and ENb output by the encoder unit 90 and the clock signal CLK are input to the conversion circuit 300. The conversion circuit 300 converts the cycles of the base position information signals ENa and ENb based on the base position information signals ENa and ENb and the clock signal CLK to generate position information signals cENa and cENb as the position information signal cENC and outputs the position information signals cENa and cENb. Here, the clock signal CLK is a signal that has a shorter cycle than the input base position information signals ENa and ENb and the output position information signals cENa and cENb and is, for example, a high-frequency signal having a frequency of 48 MHz or 100 MHz. That is, the cycle of the clock signal CLK is shorter than the cycles of the base position information signals ENa and ENb and the cycles of the position information signals cENa and cENb. The clock signal CLK may be generated by an oscillation circuit (not illustrated) that is provided outside the conversion circuit 300 and then supplied to the conversion circuit 300, or may be generated by an oscillation circuit (not illustrated) that is provided inside the conversion circuit 300.

As illustrated in FIG. 9, the conversion circuit 300 includes an edge conversion circuit 310, an edge count circuit 320, a clock count circuit 330, an output circuit 340, and a storage circuit 350. In addition, the edge conversion circuit 310 includes edge detection circuits 360a and 360b and a combination circuit 370.

The base position information signal ENa and the clock signal CLK are input to the edge detection circuit 360a. The edge detection circuit 360a acquires the input base position information signal ENa in synchronization with the clock signal CLK, removes noise from the acquired signal to generate a base position information signal fENa obtained by shaping the waveform of the base position information signal ENa, and outputs the base position information signal fENa. In addition, the edge detection circuit 360a generates an edge signal Era including a pulse signal synchronized with an edge timing when the base position information signal ENa and the base position information signal fENa corresponding to the base position information signal ENa rise from an L level to an H level and an edge signal Efa including a pulse signal synchronized with an edge timing when the base position information signal ENa and the base position information signal fENa corresponding to the base position information signal ENa fall from the H level to the L level, and outputs the generated signals.

The base position information signal ENb and the clock signal CLK are input to the edge detection circuit 360b. The edge detection circuit 360b acquires the input base position information signal ENb in synchronization with the clock signal CLK, removes noise from the acquired signal to generate a base position information signal fENb obtained by shaping the waveform of the base position information signal ENb, and outputs the base position information signal fENb. In addition, the edge detection circuit 360b generates an edge signal Erb including a pulse signal synchronized with an edge timing when the base position information signal ENb and the base position information signal fENb corresponding to the base position information signal ENb rise from an L level to an H level and an edge signal Efb including a pulse signal synchronized with an edge timing when the base position information signal ENb and the base position information signal fENb corresponding to the base position information signal ENb fall from the H level to the L level, and outputs the generated signals.

Here, an example of a specific configuration of the edge detection circuits 360a and 360b will be described. The edge detection circuits 360a and 360b have the same configuration except that the input signals and the output signals are different. Therefore, in the following description, the edge detection circuits 360a and 360b are collectively referred to as edge detection circuits 360. Further, the following description assumes that a base position information signal EN as the base position information signals ENa and ENb and the clock signal CLK are input to the edge detection circuit 360 and the edge detection circuit 360 outputs a base position information signal fEN as the base position information signals fENa and fENb, an edge signal Er as the edge signals Era and Erb, and an edge signal Ef as the edge signals Efa and Efb.

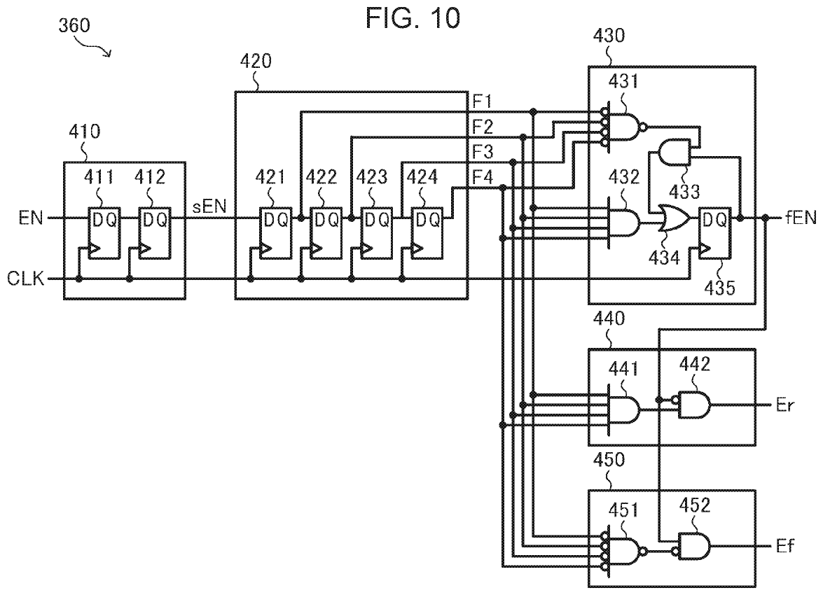

FIG. 10 is a diagram illustrating an example of a specific configuration of the edge detection circuit 360. As illustrated in FIG. 10, the edge detection circuit 360 includes a synchronization circuit 410, an extraction circuit 420, a filter circuit 430, and edge detection circuits 440 and 450.

The synchronization circuit 410 includes delay flip-flop (D-FF) circuits 411 and 412. The base position information signal EN is input to a D terminal of the D-FF circuit 411, and the clock signal CLK is input to a Clk terminal of the D-FF circuit 411. A Q terminal of the D-FF circuit 411 is electrically coupled to a D terminal of the D-FF circuit 412. The clock signal CLK is input to a Clk terminal of the D-FF circuit 412. The synchronization circuit 410 outputs the signal at a Q terminal of the D-FF circuit 412 as a base position information signal sEN obtained by synchronizing the base position information signal EN with the clock signal CLK. In the synchronization circuit 410 configured as described above, when the base position information signal EN is synchronized, the concern of a metastable state is reduced, and the base position information signal sEN obtained by synchronizing the base position information signal EN with the clock signal CLK can be output with high accuracy.

The extraction circuit 420 includes D-FF circuits 421, 422, 423, and 424. The base position information signal sEN output by the synchronization circuit 410 is input to a D terminal of the D-FF circuit 421. A Q terminal of the D-FF circuit 421 is electrically coupled to a D terminal of the D-FF circuit 422. A Q terminal of the D-FF circuit 422 is electrically coupled to a D terminal of the D-FF circuit 423. A Q terminal of the D-FF circuit 423 is electrically coupled to a D terminal of the D-FF circuit 424. That is, the D-FF circuits 421, 422, 423, and 424 are coupled in series in the order of the D-FF circuit 421, the D-FF circuit 422, the D-FF circuit 423, and the D-FF circuit 424 in a direction from the upstream to the downstream in which the signal is transmitted. In addition, the clock signal CLK is input to each of Clk terminals of the D-FF circuits 421 to 424. Then, the extraction circuit 420 outputs the signal at the Q terminal of the D-FF circuit 421 as an extraction signal F1, the signal at the Q terminal of the D-FF circuit 422 as an extraction signal F2, the signal at the Q terminal of the D-FF circuit 423 as an extraction signal F3, and the signal at the Q terminal of the D-FF circuit 424 as an extraction signal F4. That is, the extraction circuit 420 extracts the logic level of the base position information signal sEN at the timing of each rising edge of the most recent four cycles of the clock signal CLK and outputs the logic levels as the extraction signals F1 to F4.

The filter circuit 430 includes OR circuits 431 and 434, AND circuits 432 and 433, and a D-FF circuit 435. The extraction signals F1 to F4 output by the extraction circuit 420 are input to input terminals of the OR circuit 431 and input terminals of the AND circuit 432. An output terminal of the AND circuit 432 is electrically coupled to one input terminal of the OR circuit 434. An output terminal of the OR circuit 434 is electrically coupled to a D terminal of the D-FF circuit 435. A Q terminal of the D-FF circuit 435 is electrically coupled to one input terminal of the AND circuit 433. In addition, an output terminal of the OR circuit 431 is electrically coupled to the other input terminal of the AND circuit 433. An output terminal of the AND circuit 433 is electrically coupled to the other input terminal of the OR circuit 434. Then, the signal at the Q terminal of the D-FF circuit 435 is output as the base position information signal fEN from the filter circuit 430.

The filter circuit 430 configured as described above outputs the base position information signal fEN at an H level when all of the extraction signals F1 to F4 input at the timing when the clock signal CLK rises are at the H level regardless of the logic level of the output base position information signal fEN and outputs the base position information signal fEN at an L level when all of the extraction signals F1 to F4 input at the timing when the clock signal CLK rises are at the L level regardless of the logic level of the output base position information signal fEN. In addition, upon output of the H-level base position information signal fEN, when at least one of the extraction signals F1 to F4 is at the H level at the timing when the clock signal CLK rises, the filter circuit 430 continues to output the H-level base position information signal fEN. Upon output of the L-level base position information signal fEN, when at least one of the extraction signals F1 to F4 is at the L level at the timing when the clock signal CLK rises, the filter circuit 430 continues to output the L-level base position information signal fEN. That is, the filter circuit 430 outputs the base position information signal fEN at an H level when the logic level of the base position information signal sEN acquired by synchronizing the base position information signal EN with the clock signal CLK remains at the H level at the rising edge of the clock signal CLK in four consecutive cycles. The filter circuit 430 outputs the base position information signal fEN at an L level when the logic level of the base position information signal sEN acquired by synchronizing the base position information signal EN with the clock signal CLK remains at the L level at the rising edge of the clock signal CLK in four consecutive cycles. In the other cases, the filter circuit 430 does not change the logic level of the base position information signal fEN to be output. As a result, even when noise or the like is superimposed on the base position information signal EN or the base position information signal sEN, the filter circuit 430 can output the base position information signal fEN in which the influence of the noise or the like is reduced.

The edge detection circuit 440 includes AND circuits 441 and 442. The extraction signals F1 to F4 output by the extraction circuit 420 are input to input terminals of the AND circuit 441. An output terminal of the AND circuit 441 is electrically coupled to one input terminal of the AND circuit 442. A signal obtained by inverting the logic level of the base position information signal fEN output by the filter circuit 430 is input to the other input terminal of the AND circuit 442. Then, a signal at an output terminal of the AND circuit 442 is output as the edge signal Er from the edge detection circuit 440.

In the edge detection circuit 440 configured as described above, the AND circuit 441 outputs an H-level signal when all of the input extraction signals F1 to F4 are at the H level and outputs an L-level signal when at least one of the input extraction signals F1 to F4 is at the L level. Further, as described above, the filter circuit 430 outputs the H-level base position information signal fEN when all of the extraction signals F1 to F4 are at the H level. At this time, since the filter circuit 430 includes the D-FF circuit 435, the timing from the input of the H-level extraction signals F1 to F4 to the filter circuit 430 to the output of the H-level base position information signal fEN by the filter circuit 430 is delayed by one clock of the clock signal CLK from the timing from the input of the H-level extraction signals F1 to F4 to the AND circuit 441 to the output of the H-level signal by the AND circuit 441. Therefore, the edge detection circuit 440 outputs, as the edge signal Er, a signal that remains at the H level for a period corresponding to one clock of the clock signal CLK after all of the extraction signals F1 to F4 change to the H level. In other words, the edge detection circuit 440 outputs, as the edge signal Er, the pulse signal synchronized with the timing when the base position information signal EN or the base position information signal sEN rises.

The edge detection circuit 450 includes an OR circuit 451 and an AND circuit 452. The extraction signals F1 to F4 output by the extraction circuit 420 are input to input terminals of the OR circuit 451. A signal at an output terminal of the OR circuit 451 is subjected to logic level inversion and then input to one input terminal of the AND circuit 452. The base position information signal fEN output by the filter circuit 430 is input to the other input terminal of the AND circuit 452. Then, a signal at an output terminal of the AND circuit 452 is output as the edge signal Ef from the edge detection circuit 450.

In the edge detection circuit 450 configured as described above, the OR circuit 451 outputs an L-level signal when all of the input extraction signals F1 to F4 are at the L level and outputs an H-level signal when at least one of the input extraction signals F1 to F4 is at the H level. That is, an H-level signal is input to the one input terminal of the AND circuit 452 when all of the extraction signals F1 to F4 are at the L level, and an L-level signal is input to the one input terminal of the AND circuit 452 when at least one of the extraction signals F1 to F4 is at the H level. Further, as described above, the filter circuit 430 outputs the L-level base position information signal fEN when all of the extraction signals F1 to F4 are at the L level. At this time, since the filter circuit 430 includes the D-FF circuit 435, the timing from the input of the L-level extraction signals F1 to F4 to the filter circuit 430 to the output of the L-level base position information signal fEN by the filter circuit 430 is delayed by one clock of the clock signal CLK from the timing from the input of the L-level extraction signals F1 to F4 to the OR circuit 451 to the output of the L-level signal by the OR circuit 451. Therefore, the edge detection circuit 450 outputs, as the edge signal Ef, a signal that remains at the H level for a period corresponding to one clock of the clock signal CLK after all of the extraction signals F1 to F4 change to the L level. In other words, the edge detection circuit 450 outputs, as the edge signal Ef, the pulse signal synchronized with the timing when the base position information signal EN or the base position information signal sEN falls.

As described above, the edge detection circuit 360 acquires the input base position information signal EN in synchronization with the clock signal CLK, removes noise from the acquired signal to generate the base position information signal fEN obtained by shaping the waveform of the base position information signal EN, and outputs the base position information signal fEN. In addition, the edge detection circuit 360 generates the edge signal Er synchronized with the timing when the base position information signals EN and fEN rise from the L level to the H level and the edge signal Ef synchronized with the timing when the base position information signals EN and fEN fall from the H level to the L level and outputs the edge signals Er and Ef.

Returning to FIG. 9, the edge signals Era and Efa output by the edge detection circuit 360a, the edge signals Erb and Efb output by the edge detection circuit 360b, and the clock signal CLK are input to the combination circuit 370. The combination circuit 370 combines the edge signals Era, Efa, Erb, and Efb to generate a composite edge signal eEG and outputs the composite edge signal eEG.

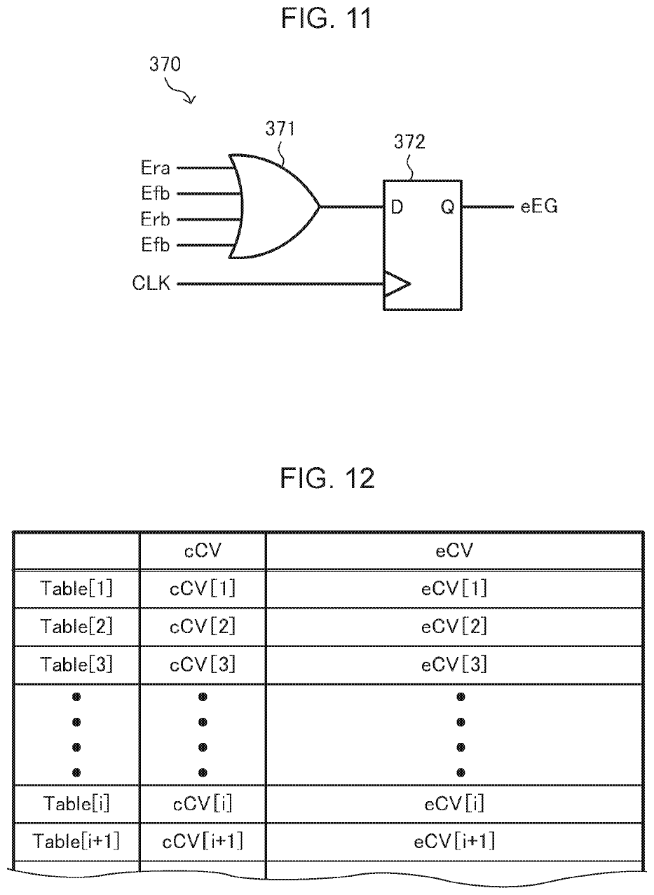

FIG. 11 is a diagram illustrating an example of a specific configuration of the combination circuit 370. As illustrated in FIG. 11, the combination circuit 370 has an OR circuit 371 and a D-FF circuit 372. The edge signals Era and Efa output by the edge detection circuit 360a and the edge signals Erb and Efb output by the edge detection circuit 360b are input to input terminals of the OR circuit 371. An output terminal of the OR circuit 371 is electrically coupled to a D terminal of the D-FF circuit 372. The clock signal CLK is input to a Clk terminal of the D-FF circuit 372. Then, the combination circuit 370 outputs a signal at a Q terminal of the D-FF circuit 372 as the composite edge signal eEG.

Specifically, the OR circuit 371 outputs a signal that is at an H level when at least one of the edge signals Era, Efa, Erb, and Efb is at the H level and is at an L level when all of the edge signals Era, Efa, Erb, and Efb are at the L level. That is, the OR circuit 371 outputs a pulse signal that remains at an H level for a predetermined period at the rising or falling edge of at least one of the base position information signals ENa and ENb. Then, at the rising edge of the clock signal CLK, the D-FF circuit 372 acquires the output signal of the OR circuit 371 and outputs the acquired output signal as the composite edge signal eEG. That is, the combination circuit 370 outputs, as the composite edge signal eEG, the pulse signal that remains at the H level for a predetermined period at the rising or falling edge of at least one of the base position information signals ENa and ENb.

Returning to FIG. 9, the composite edge signal eEG output by the edge conversion circuit 310 is input to the edge count circuit 320. The edge count circuit 320 counts the number of rising edges of the composite edge signal eEG and outputs an edge count signal eCNT corresponding to the count value. The edge count circuit 320 may be configured to include a known count-up circuit that counts up each time it detects the rising edge of the composite edge signal eEG and outputs the count value as the edge count signal eCNT. That is, the conversion circuit 300 includes the edge count circuit 320 that counts the number of edges of the base position information signals ENa and ENb as the base position information signal ENC which is the number of rising edges of the composite edge signal eEG.

The composite edge signal eEG output by the edge conversion circuit 310 and the clock signal CLK are input to the clock count circuit 330. The clock count circuit 330 counts the number of rising edges of the clock signal CLK, and outputs a clock count signal cCNT corresponding to the count value. In addition, the count value in the clock count circuit 330 is reset at the rising edge of the composite edge signal eEG. In other words, the count result of the number of rising edges of the clock signal CLK in the clock count circuit 330, which is the count result of the number of pulse signals of the clock signal CLK, is reset at the timing at which the logic levels of the base position information signals ENa and ENb as the base position information signal ENC change. As a result, the clock count circuit 330 counts the number of rising edges of the clock signal CLK between the rising edges of the composite edge signal eEG, and outputs a clock count signal cCNT corresponding to the count value. The clock count circuit 330 can use a known count-up circuit that counts up each time it detects the rising edge of the clock signal CLK and outputs the count value as the clock count signal cCNT. That is, the conversion circuit 300 includes the clock count circuit 330 that counts the number of pulses of the clock signal CLK.

The base position information signals fENa and fENb, the edge signals Era, Efa, Erb, and Efb, the edge count signal eCNT, and the clock count signal cCNT are input to the output circuit 340.

The output circuit 340 specifies the movement direction of the carriage 21 along the scanning axis based on the base position information signals fENa and fENb and the edge signals Era, Efa, Erb, and Efb. Specifically, the output circuit 340 determines that the carriage 21 is moving from one side to the other side along the scanning axis when the edge signal Era is at the H level and the base position information signal fENb is at the L level, when the edge signal Erb is at the H level and the base position information signal fENa is at the H level, when the edge signal Efa is at the H level and the base position information signal fENb is at the H level, and when the edge signal Efb is at the H level and the base position information signal fENa is at the L level. In addition, the output circuit 340 determines that the carriage 21 is moved from the other side to one side along the scanning axis when the edge signal Era is at the H level and the base position information signal fENb is at the H level, when the edge signal Erb is at the H level and the base position information signal fENa is at the L level, when the edge signal Efa is at the H level and the base position information signal fENb is at the L level, and when the edge signal Efb is at the H level and the base position information signal fENa is at the H level.

The output circuit 340 reads, from the storage circuit 350, the conversion timing information items eCV and cCV for defining the timing of changing the logic levels of the position information signals cENa and cENb as the position information signal cENC to be output, according to the determined movement direction of the carriage 21 along the scanning axis. FIG. 12 is a diagram illustrating an example of a data structure stored in the storage circuit 350. As illustrated in FIG. 12, the storage circuit 350 has a data table in which conversion timing information items eCV[1] to eCV[s] (s is any natural number) as a plurality of conversion timing information items eCV and conversion timing information items cCV[1] to cCV[s] as a plurality of conversion timing information items cCV are stored in a one-to-one correspondence. Specifically, in the data table configured in the storage circuit 350, a value as the conversion timing information eCV[1] and a value as the conversion timing information cCV[1] are stored at an address corresponding to Table[1], and a value as the conversion timing information eCV[i] and a value as the conversion timing information cCV[i] are stored at an address corresponding to Table[i] (i is any natural number in the range from 1 to s).

When the conversion timing information items eCV[i] and cCV[i] stored in Table[i] are read, the output circuit 340 generates a read request signal rCV including information for designating an address corresponding to Table[i] and outputs the read request signal rCV to the storage circuit 350. The storage circuit 350 acquires the conversion timing information items eCV[i] and cCV[i] stored in Table[i] of the data table at the address designated by the input read request signal rCV. Then, the storage circuit 350 generates a read information signal aCV including the acquired conversion timing information items eCV[i] and cCV[i] and outputs the read information signal aCV to the output circuit 340.

The following description assumes that the conversion timing information items eCV[1] and cCV[1] as the conversion timing information items eCV and cCV stored at the address corresponding to Table[1] are the conversion timing information items eCV and cCV defining the start timing of a first cycle Ta from a predetermined reference point, and the conversion timing information items eCV[i] and cCV[i] as the conversion timing information items eCV and cCV stored at the address corresponding to Table[i] are the conversion timing information items eCV and cCV defining the start timing of an i-th cycle Ta from the predetermined reference point. Here, the cycle Ta corresponds to a repetition period from the timing when the logic level of any one of the position information signals cENa and cENb changes to the next timing when the logic level of any one of the position information signals cENa and cENb changes.

In addition, the data table corresponding to when the carriage 21 is moved from one side to the other side along the scanning axis and the data table corresponding to when the carriage 21 is moved from the other side to one side along the scanning axis may be the same data table. In this case, the output circuit 340 may acquire the conversion timing information items eCV and cCV from the storage circuit 350, regardless of the determination result of the movement direction of the carriage 21 along the scanning axis of the carriage 21. Therefore, the output circuit 340 may read the conversion timing information items eCV and cCV from the data table of the storage circuit 350, for example, at the timing when a power supply voltage is applied to the printing apparatus 1.

The conversion timing information eCV is information for defining the timing when the logic levels of the position information signals cENa and cENb as the position information signal cENC are changed according to the amount of movement of the carriage 21 detected based on the base position information signal ENC. The storage circuit 350 stores, for example, as the conversion timing information eCV, the value of the integer part of the quotient when the ideal amount of movement of the print head 22 in the ideal cycle Tp is divided by the resolution of the encoder unit 90. Specifically, when the resolution of the printing apparatus 1 is 600 dpi and the resolution of the encoder unit 90 is 1 μm, the amount of movement of the carriage 21 in the ideal cycle Tp is 42.333 . . . μm. At this time, “42”, which is the value of the integer part of the value obtained by dividing 42.333 . . . μm by 1 μm, which is the resolution of the encoder unit 90, is stored in the conversion timing information eCV[1], “84”, which is the value of the integer part of the value obtained by dividing 84.666 . . . μm, which is twice 42.333 . . . μm, by 1 μm, which is the resolution of the encoder unit 90, is stored in the conversion timing information eCV[2], and “127”, which is the value of the integer part of the value obtained by dividing 127.0 μm, which is three times 42.333 . . . μm, by 1 μm, which is the resolution of the encoder unit 90, is stored in the conversion timing information eCV[3]. Further, the values obtained by the same calculation as described above are stored in the conversion timing information items eCV[4] to eCV[s], which will not be described.

The conversion timing information cCV is information for correcting an error between the amount of movement of the carriage 21 detectable based on the base position information signal ENC and the ideal amount of movement of the carriage 21 in the ideal cycle Tp. The storage circuit 350 stores, as the conversion timing information cCV, a value obtained by multiplying the quotient obtained by dividing the value of the fractional part of the quotient, which is obtained by dividing the ideal amount of movement of the print head 22 in the ideal cycle Tp by the resolution of the encoder unit 90, by the moving speed of the carriage 21, by the frequency of the clock signal CLK. Specifically, when the resolution of the printing apparatus 1 is 600 dpi, the resolution of the encoder unit 90 is 1 μm, the moving speed of the carriage 21 along the scanning axis is 0.3 m/s, and the frequency of the clock signal CLK is 48 MHz, “53” corresponding to 0.333 . . . , which is the value of the fractional part of the value obtained by dividing 42.333 . . . μm, which is the amount of movement of the carriage 21 in the ideal cycle Tp, by 1 μm, which is the resolution of the encoder unit 90, is stored in the conversion timing information cCV[1], “107” corresponding to 0.666 . . . , which is the value of the fractional part of the value obtained by dividing 84.666 . . . μm, which is twice the amount of movement of the carriage 21 in the ideal cycle Tp, by 1 μm, which is the resolution of the encoder unit 90, is stored in the conversion timing information cCV[2], and “0” corresponding to 0, which is the value of the fractional part of the value obtained by dividing 127.0 μm, which is three times the amount of movement of the carriage 21 in the ideal cycle Tp, by 1 μm, which is the resolution of the encoder unit 90, is stored in the conversion timing information cCV[3]. Further, the conversion timing information items cCV[4] to cCV[s] store the values obtained by the same calculation as described above, which will not be described.

Here, the values of the conversion timing information items eCV and cCV stored in the storage circuit 350 may be rewritten according to the specifications of the printing apparatus 1. Therefore, even when the specifications of the printing apparatus 1 are changed, it is possible to improve versatility.

Returning to FIG. 9, the output circuit 340 generates the position information signals cENa and cENb whose logic levels change at a timing corresponding to the edge count signal eCNT, the clock count signal cCNT, and the conversion timing information eCV and cCV, and outputs the position information signals cENa and cENb to the control circuit 100.

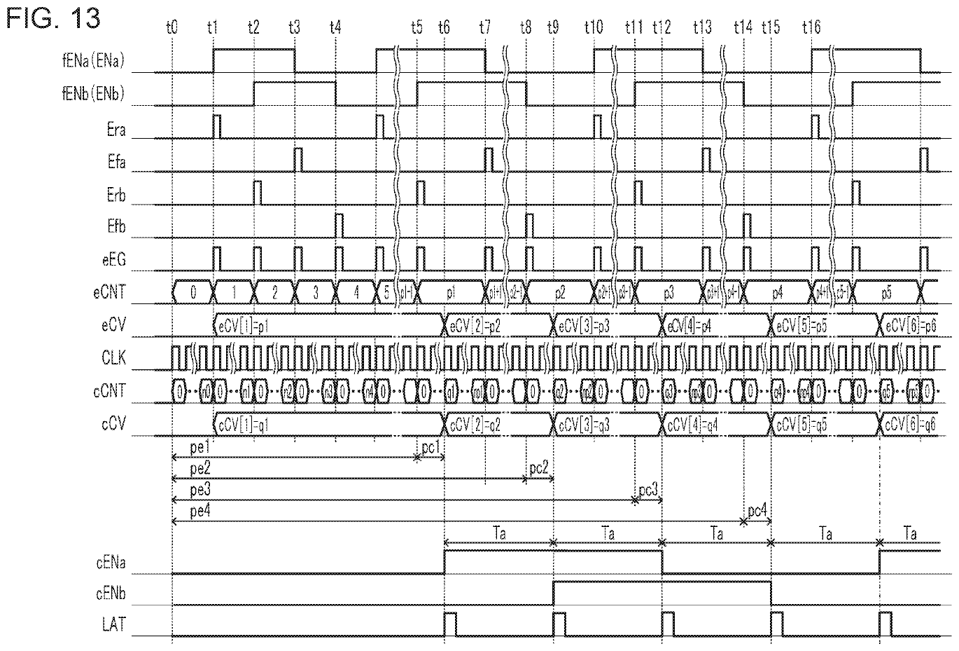

FIG. 13 is a diagram illustrating a specific example of a method for generating the position information signals cENa and cENb. Here, as described above, the base position information signal fENa is a signal obtained by removing noise components of the base position information signal ENa, and the base position information signal fENb is a signal obtained by removing noise components of the base position information signal ENb. In view of the above, it can be considered that the base position information signal fENa and the base position information signal ENa are the same signal and that the base position information signal fENb and the base position information signal ENb are the same signal. Therefore, hereinafter, the description will be made using the base position information signals fENa and fENb. However, the same effect can be obtained even when the base position information signals fENa and fENb are read as the base position information signals ENa and ENb.

As illustrated in FIG. 13, at a time t0, the carriage 21 on which the print head 22 is mounted starts to move. At this time, in the example illustrated in FIG. 13, it is assumed that all of the base position information signals fENa and fENb and the position information signals cENa and cENb are at the L level. In addition, the base position information signals fENa and fENb and the position information signals cENa and cENb immediately before the carriage 21 starts to move are not limited to the L level.

At a time t1 after the carriage 21 starts to move at the time t0, the base position information signal fENa changes from the L level to the H level. Therefore, the edge detection circuit 360a outputs a pulse signal as the edge signal Era. The output circuit 340 determines the movement direction of the carriage 21 based on the logic level of the base position information signal fENb when the pulse signal is input as the edge signal Era. Then, the output circuit 340 selects the data table stored in the storage circuit 350 according to the determined movement direction of the carriage 21, and reads and holds the conversion timing information items eCV[1] and cCV[1] stored in Table[1] of the selected data table. Here, the description assumes that the conversion timing information eCV[1] read by the output circuit 340 is any value p1 and the conversion timing information cCV[1] is any value q1.

In addition, at the time t1, when the edge detection circuit 360a outputs a pulse signal as the edge signal Era, the combination circuit 370 outputs a pulse signal as the composite edge signal eEG. Then, the edge count circuit 320 detects the edge of the pulse signal included in the composite edge signal eEG, and thus the count value of the edge count signal eCNT input to the output circuit 340 increases. The output circuit 340 compares the count value included in the input edge count signal eCNT with the value p1 which is the conversion timing information eCV[1].

At time t2, the base position information signal fENb changes from the L level to the H level. At this time, the edge detection circuit 360b outputs a pulse signal as the edge signal Erb, and the combination circuit 370 outputs a pulse signal as the composite edge signal eEG. Then, the edge count circuit 320 detects the edge of the pulse signal included in the composite edge signal eEG, and thus the count value of the edge count signal eCNT input to the output circuit 340 increases. The output circuit 340 compares the count value included in the input edge count signal eCNT with the value p1 which is the conversion timing information eCV[1].

At a time t3, the base position information signal fENa changes from the H level to the L level. At this time, the edge detection circuit 360a outputs a pulse signal as the edge signal Efa, and the combination circuit 370 outputs a pulse signal as the composite edge signal eEG. Then, the edge count circuit 320 detects the edge of the pulse signal included in the composite edge signal eEG, and thus the count value of the edge count signal eCNT input to the output circuit 340 increases. The output circuit 340 compares the count value included in the input edge count signal eCNT with the value p1 which is the conversion timing information eCV[1].

At a time t4, the base position information signal fENb changes from the H level to the L level. At this time, the edge detection circuit 360b outputs a pulse signal as the edge signal Efb, and the combination circuit 370 outputs a pulse signal as the composite edge signal eEG. Then, the edge count circuit 320 detects the edge of the pulse signal included in the composite edge signal eEG, and thus the count value of the edge count signal eCNT input to the output circuit 340 increases. The output circuit 340 compares the count value included in the input edge count signal eCNT with the value p1 which is the conversion timing information eCV[1].

After the time t4, the logic levels of the base position information signals ENa and ENb output by the encoder unit 90 and the logic levels of the base position information signals fENa and fENb input to the output circuit 340 repeatedly change in the above-described order according to the amount of movement of the carriage 21. At this time, the count value of the edge count signal eCNT input to the output circuit 340 increases at each of the timing when the logic level of the base position information signal fENa changes and the timing when the logic level of the base position information signal fENb changes. The output circuit 340 compares the count value included in the input edge count signal eCNT with the value p1, which is the conversion timing information eCV[1], each time and continues to output the position information signals cENa and cENb, whose logic levels do not change and are constant, for the period until the count value included in the input edge count signal eCNT reaches the value p1 which is the conversion timing information eCV[1].

At this time, at the timing when the logic level of the base position information signal ENC output by the encoder unit 90 is switched, for example, within the edge interval of the base position information signals ENa and ENb, that is, within the edge interval of the composite edge signal eEG, the amount of movement of the carriage 21 corresponds to the resolution of the encoder unit 90. Specifically, this means that, when the resolution of the encoder unit 90 is 1 μm, the carriage 21 is moved by 1 μm at the timing when the logic level of the base position information signal ENC is switched, for example, during each of the period from the time t1 to the time t2, the period from the time t2 to the time t3, and the period from the time t3 to the time t4 which are the edge intervals between the base position information signals ENa and ENb. In other words, the encoder unit 90 outputs the base position information signals ENa and ENb as the base position information signal ENC, whose logic level changes, each time the carriage 21 is moved by a distance defined by the resolution of the encoder unit 90.

Then, at a time t5, when the count value included in the edge count signal eCNT input to the output circuit 340 reaches the value p1 which is the conversion timing information eCV[1], the output circuit 340 starts to acquire the count value included in the clock count signal cCNT output by the clock count circuit 330. Then, the output circuit 340 compares the count value included in the input clock count signal cCNT with the value q1 which is the conversion timing information cCV[1].

At the subsequent time t6, when the count value included in the clock count signal cCNT input to the output circuit 340 reaches the value q1 which is the conversion timing information cCV[1], the output circuit 340 inverts the logic level of the position information signal cENa or the position information signal cENb to be output. Specifically, when the logic levels of the position information signal cENa and the position information signal cENb output immediately before the time t6 are the same, the output circuit 340 inverts the logic level of the position information signal cENa at the time t6. When the logic levels of the position information signal cENa and the position information signal cENb output immediately before the time t6 are different from each other, the output circuit 340 inverts the logic level of the position information signal cENb at the time t6. That is, in the example illustrated in FIG. 13, at the time t6, the output circuit 340 inverts the position information signal cENa to be output from the L level to the H level and does not invert the logic level of the position information signal cENb to be output.

As described above, the output circuit 340 outputs the position information signal cENC, whose logic level changes, at the timing at which the count result of the number of pulses of the clock signal CLK in the clock count circuit 330 reaches the value q1 which is the conversion timing information cCV[1], after the count result of the number of edges of the base position information signals fENa and fENb which are the base position information signal ENC, which is the count result of the number of edges of the base position information signals ENa and ENb which are the base position information signal ENC in the edge count circuit 320, reaches the value p1, which is the conversion timing information eCV[1]. That is, the output circuit 340 detects the scanning position of the carriage 21 according to the edge interval between the base position information signals ENa and ENb, which are the base position information signal ENC, during the period pe1 until the count result of the number of edges of the base position information signals fENa and fENb, which are the base position information signal ENC, reaches the value p1, which is the conversion timing information eCV[1], and corrects the scanning position of the carriage 21 according to the pulse cycle of the clock signal CLK during the period pc1 until the count result of the number of pulses of the clock signal CLK in the clock count circuit 330 reaches the value q1, which is the conversion timing information cCV[1], after the period pe1. Then, the output circuit 340 outputs the position information signal cENC whose logic level changes at the timing when the sum of the period pe1 and the period pc1 has elapsed, which is the timing when the scanning position of the carriage 21 is corrected. In other words, the conversion circuit 300 including the output circuit 340 acquires the base position information signals ENa and ENb, which are the base position information signal ENC output by the encoder unit 90, and the clock signal CLK having a predetermined cycle, and outputs the position information signal cENC including the position information signals cENa and cENb corresponding to the sum of at least one edge interval among the edge intervals of the base position information signals ENa and ENb, which are the base position information signal ENC, and at least one pulse cycle among the pulse cycles of the clock signal CLK.

In addition, at the time t6, the output circuit 340 inverts the logic level of the position information signal cENa or the position information signal cENb to be output and then updates the held conversion timing information items eCV and cCV. Specifically, the output circuit 340 inverts the logic level of the position information signal cENa or the position information signal cENb to be output, reads the conversion timing information items eCV[2] and cCV[2] stored in Table[2] from the corresponding data table of the storage circuit 350, and then holds the conversion timing information items eCV[2] and cCV[2]. Here, the description assumes that the conversion timing information eCV[2] read by the output circuit 340 is any value p2 larger than the value p1 and the conversion timing information cCV[2] is any value q2.

Then, at a time t7 after the time t6, the logic level of one of the base position information signals fENa and fENb is changed from the H level to the L level. In the example illustrated in FIG. 13, the logic level of the base position information signal fENa is changed from the H level to the L level. At this time, the edge detection circuit 360a outputs a pulse signal as the edge signal Efa, and the combination circuit 370 outputs a pulse signal as the composite edge signal eEG. Then, the edge count circuit 320 detects the edge of the pulse signal included in the composite edge signal eEG, and thus the count value of the edge count signal eCNT input to the output circuit 340 increases. The output circuit 340 compares the count value included in the input edge count signal eCNT with the value p2 which is the conversion timing information eCV[2].

At a time t8, when the count value included in the edge count signal eCNT input to the output circuit 340 reaches the value p2 which is the conversion timing information eCV[2], the output circuit 340 starts to acquire the count value included in the clock count signal cCNT output by the clock count circuit 330. Then, the output circuit 340 compares the count value included in the input clock count signal cCNT with the value q2 which is the conversion timing information cCV[2].

At the subsequent time t9, when the count value included in the clock count signal cCNT input to the output circuit 340 reaches the value q2 which is the conversion timing information cCV[2], the output circuit 340 inverts the logic level of the position information signal cENa or the position information signal cENb to be output. Specifically, the output circuit 340 inverts the logic level of the position information signal cENa at the time t9 when the logic levels of the position information signal cENa and the position information signal cENb output immediately before the time t9 are the same, and inverts the logic level of the position information signal cENb at the time t9 when the logic levels of the position information signal cENa and the position information signal cENb output immediately before the time t9 are different from each other. That is, in the example illustrated in FIG. 13, at the time t9, the output circuit 340 does not invert the logic level of the position information signal cENa to be output and inverts the logic level of the position information signal cENb to be output from the L level to the H level.

As described above, the output circuit 340 outputs the position information signal cENC, whose logic level changes, at the timing at which the count result of the number of pulses of the clock signal CLK in the clock count circuit 330 reaches the value q2 which is the conversion timing information cCV[2], after the count result of the number of edges of the base position information signals fENa and fENb which are the base position information signal ENC, which is the count result of the number of edges of the base position information signals ENa and ENb which are the base position information signal ENC in the edge count circuit 320, reaches the value p2, which is the conversion timing information eCV[2]. That is, the output circuit 340 detects the scanning position of the carriage 21 according to the edge interval between the base position information signals ENa and ENb, which are the base position information signal ENC, during the period pe2 until the count result of the number of edges of the base position information signals fENa and fENb, which are the base position information signal ENC, reaches the value p2, which is the conversion timing information eCV[2], and corrects the scanning position of the carriage 21 according to the pulse cycle of the clock signal CLK during the period pc2 until the count result of the number of pulses of the clock signal CLK in the clock count circuit 330 reaches the value q2, which is the conversion timing information cCV[2], after the period pe2. Then, the output circuit 340 outputs the position information signal cENC whose logic level changes at the timing when the sum of the period pe2 and the period pc2 has elapsed, which is the timing when the scanning position of the carriage 21 is corrected. In other words, the conversion circuit 300 including the output circuit 340 acquires the base position information signals ENa and ENb, which are the base position information signal ENC output by the encoder unit 90, and the clock signal CLK having a predetermined cycle, and outputs the position information signal cENC including the position information signals cENa and cENb corresponding to the sum of at least one edge interval among the edge intervals of the base position information signals ENa and ENb, which are the base position information signal ENC, and at least one pulse cycle among the pulse cycles of the clock signal CLK.

In addition, at the time t9, the output circuit 340 inverts the logic level of the position information signal cENa or the position information signal cENb to be output and then updates the held conversion timing information items eCV and cCV. Specifically, the output circuit 340 inverts the logic level of the position information signal cENa or the position information signal cENb to be output, reads the conversion timing information items eCV[3] and cCV[3] stored in Table[3] from the corresponding data table of the storage circuit 350, and then holds the conversion timing information items eCV[3] and cCV[3]. Here, the description assumes that the conversion timing information eCV[3] read by the output circuit 340 is any value p3 larger than the value p2 and the conversion timing information cCV[3] is any value q3.

Then, at a time t10 after time t9, the logic level of one of the base position information signals fENa and fENb is changed from the L level to the H level. In the example illustrated in FIG. 13, the logic level of the base position information signal fENa is changed from the L level to the H level. At this time, the edge detection circuit 360a outputs a pulse signal as the edge signal Era, and the combination circuit 370 outputs a pulse signal as the composite edge signal eEG. Then, the edge count circuit 320 detects the edge of the pulse signal included in the composite edge signal eEG, and thus the count value of the edge count signal eCNT input to the output circuit 340 increases. The output circuit 340 compares the count value included in the input edge count signal eCNT with the value p3 which is the conversion timing information eCV[3].

At a time t11, when the count value included in the edge count signal eCNT input to the output circuit 340 reaches the value p3 which is the conversion timing information eCV[3], the output circuit 340 starts to acquire the count value included in the clock count signal cCNT output by the clock count circuit 330. Then, the output circuit 340 compares the count value included in the input clock count signal cCNT with the value q3 which is the conversion timing information cCV[3].

At the subsequent time t12, when the count value included in the clock count signal cCNT input to the output circuit 340 reaches the value q3 which is the conversion timing information cCV[3], the output circuit 340 inverts the logic level of the position information signal cENa or the position information signal cENb to be output. Specifically, the output circuit 340 inverts the logic level of the position information signal cENa at the time t12 when the logic levels of the position information signal cENa and the position information signal cENb output immediately before the time t12 are the same, and inverts the logic level of the position information signal cENb at the time t12 when the logic levels of the position information signal cENa and the position information signal cENb output immediately before the time t12 are different from each other. That is, in the example illustrated in FIG. 13, at the time t12, the output circuit 340 inverts the logic level of the position information signal cENa to be output from the H level to the L level, and does not invert the logic level of the position information signal cENb to be output.

As described above, the output circuit 340 outputs the position information signal cENC, whose logic level changes, at the timing at which the count result of the number of pulses of the clock signal CLK in the clock count circuit 330 reaches the value q3 which is the conversion timing information cCV[3], after the count result of the number of edges of the base position information signals fENa and fENb which are the base position information signal ENC, which is the count result of the number of edges of the base position information signals ENa and ENb which are the base position information signal ENC in the edge count circuit 320, reaches the value p3, which is the conversion timing information eCV[3]. That is, the output circuit 340 detects the scanning position of the carriage 21 according to the edge interval between the base position information signals ENa and ENb, which are the base position information signal ENC, during the period pe3 until the count result of the number of edges of the base position information signals fENa and fENb, which are the base position information signal ENC, reaches the value p3, which is the conversion timing information eCV[3], and corrects the scanning position of the carriage 21 according to the pulse cycle of the clock signal CLK during the period pc3 until the count result of the number of pulses of the clock signal CLK in the clock count circuit 330 reaches the value q3, which is the conversion timing information cCV[3], after the period pe3. Then, the output circuit 340 outputs the position information signal cENC whose logic level changes at the timing when the sum of the period pe3 and the period pc3 has elapsed, which is the timing when the scanning position of the carriage 21 is corrected. In other words, the conversion circuit 300 including the output circuit 340 acquires the base position information signals ENa and ENb, which are the base position information signal ENC output by the encoder unit 90, and the clock signal CLK having a predetermined cycle, and outputs the position information signal cENC including the position information signals cENa and cENb corresponding to the sum of at least one edge interval among the edge intervals of the base position information signals ENa and ENb, which are the base position information signal ENC, and at least one pulse cycle among the pulse cycles of the clock signal CLK.

In addition, at the time t12, the output circuit 340 inverts the logic level of the position information signal cENa or the position information signal cENb to be output and then updates the held conversion timing information items eCV and cCV. Specifically, the output circuit 340 inverts the logic level of the position information signal cENa or the position information signal cENb to be output, reads the conversion timing information items eCV[4] and cCV[4] stored in Table[4] from the corresponding data table of the storage circuit 350, and holds the conversion timing information items eCV[4] and cCV[4]. Here, the description assumes that the conversion timing information eCV[4] read by the output circuit 340 is any value p4 larger than the value p3 and the conversion timing information cCV[4] is any value q4.

Then, at a time t13 after the time t12, the logic level of one of the base position information signals fENa and fENb is changed from the H level to the L level. In the example illustrated in FIG. 13, the logic level of the base position information signal fENa is changed from the H level to the L level. At this time, the edge detection circuit 360a outputs a pulse signal as the edge signal Efa, and the combination circuit 370 outputs a pulse signal as the composite edge signal eEG. Then, the edge count circuit 320 detects the edge of the pulse signal included in the composite edge signal eEG, and thus the count value of the edge count signal eCNT input to the output circuit 340 increases. The output circuit 340 compares the count value included in the input edge count signal eCNT with the value p4 which is the conversion timing information eCV[4].

At a time t14, when the count value included in the edge count signal eCNT input to the output circuit 340 reaches the value p4 which is the conversion timing information eCV[4], the output circuit 340 starts to acquire the count value included in the clock count signal cCNT output by the clock count circuit 330. Then, the output circuit 340 compares the count value included in the input clock count signal cCNT with the value q4 which is the conversion timing information cCV[4].

At the subsequent time t15, when the count value included in the clock count signal cCNT input to the output circuit 340 reaches the value q4 which is the conversion timing information cCV[4], the output circuit 340 inverts the logic level of the position information signal cENa or the position information signal cENb to be output. Specifically, the output circuit 340 inverts the logic level of the position information signal cENa at time t15 when the logic levels of the position information signal cENa and the position information signal cENb output immediately before the time t15 are the same, and inverts the logic level of the position information signal cENb at the time t15 when the logic levels of the position information signal cENa and the position information signal cENb output immediately before the time t15 are different from each other. That is, in the example illustrated in FIG. 13, at the time t15, the output circuit 340 does not invert the logic level of the position information signal cENa to be output, and inverts the logic level of the position information signal cENb to be output from the H level to the L level.

As described above, the output circuit 340 outputs the position information signal cENC, whose logic level changes, at the timing at which the count result of the number of pulses of the clock signal CLK in the clock count circuit 330 reaches the value q4 which is the conversion timing information cCV[4], after the count result of the number of edges of the base position information signals fENa and fENb which are the base position information signal ENC, which is the count result of the number of edges of the base position information signals ENa and ENb which are the base position information signal ENC in the edge count circuit 320, reaches the value p4, which is the conversion timing information eCV[4]. That is, the output circuit 340 detects the scanning position of the carriage 21 according to the edge interval between the base position information signals ENa and ENb, which are the base position information signal ENC, during the period pe4 until the count result of the number of edges of the base position information signals fENa and fENb, which are the base position information signal ENC, reaches the value p4, which is the conversion timing information eCV[4], and corrects the scanning position of the carriage 21 according to the pulse cycle of the clock signal CLK during the period pc4 until the count result of the number of pulses of the clock signal CLK in the clock count circuit 330 reaches the value q4, which is the conversion timing information cCV[4], after the period pe4. Then, the output circuit 340 outputs the position information signal cENC whose logic level changes at the timing when the sum of the period pe4 and the period pc4 has elapsed, which is the timing when the scanning position of the carriage 21 is corrected. In other words, the conversion circuit 300 including the output circuit 340 acquires the base position information signals ENa and ENb, which are the base position information signal ENC output by the encoder unit 90, and the clock signal CLK having a predetermined cycle, and outputs the position information signal cENC including the position information signals cENa and cENb corresponding to the sum of at least one edge interval among the edge intervals of the base position information signals ENa and ENb, which are the base position information signal ENC, and at least one pulse cycle among the pulse cycles of the clock signal CLK.

In addition, at the time t15, the output circuit 340 inverts the logic level of the position information signal cENa or the position information signal cENb to be output and then updates the held conversion timing information items eCV and cCV. Specifically, the output circuit 340 inverts the logic level of the position information signal cENa or the position information signal cENb to be output, reads the conversion timing information items eCV[5] and cCV[5] stored in Table[5] from the corresponding data table of the storage circuit 350, and then holds the conversion timing information items eCV[5] and cCV[5]. Here, the description assumes that the conversion timing information eCV[5] read by the output circuit 340 is any value p5 larger than the value p4 and the conversion timing information cCV[5] is any value q5.

Then, at a time t16 after time t15, the logic level of one of the base position information signals fENa and fENb is changed from the L level to the H level. In the example illustrated in FIG. 13, the logic level of the base position information signal fENa is changed from the L level to the H level. At this time, the edge detection circuit 360a outputs a pulse signal as the edge signal Era, and the combination circuit 370 outputs a pulse signal as the composite edge signal eEG. Then, the edge count circuit 320 detects the edge of the pulse signal included in the composite edge signal eEG, and thus the count value of the edge count signal eCNT input to the output circuit 340 increases. The output circuit 340 compares the count value included in the input edge count signal eCNT with the value p5 which is the conversion timing information eCV[5].

After the time t16, the conversion circuit 300 including the output circuit 340 repeatedly executes the operation illustrated in FIG. 13 during the period in which the carriage 21 is moved from one side to the other side along the scanning axis. That is, the conversion circuit 300 including the output circuit 340 generates the position information signals cENa and cENb whose logic levels change at a timing corresponding to the edge count signal eCNT, the clock count signal cCNT, and the conversion timing information eCV and cCV, which are the position information signal cENC whose logic level changes according to the amount of movement of the carriage 21, during the period in which the carriage 21 is moved from one side to the other side along the scanning axis, and outputs the position information signal cENC to the control circuit 100. In other words, the conversion circuit 300 including the output circuit 340 generates the position information signal cENC whose logic level changes according to the amount of movement of the carriage 21 even during any of an acceleration period in which the carriage 21 accelerates, a constant speed period in which the carriage 21 is moved at a constant speed, and a deceleration period in which the carriage 21 decelerates, and outputs the position information signal cENC to the control circuit 100.

As described above, the logic level of the position information signal cENa rises at the time t6 which is the timing defined by the conversion timing information items eCV[1] and cCV[1]. The logic level of the position information signal cENb rises at the time t9 which is the timing defined by the conversion timing information items eCV[2] and cCV[2]. The logic level of the position information signal cENa falls at the time t12 which is the timing defined by the conversion timing information items eCV[3] and cCV[3]. The logic level of the position information signal cENb falls at the time t15 which is the timing defined by the conversion timing information items eCV[4] and cCV[4]. At this time, each of the period from the time t6 as the start timing to the time t9 as the end timing, the period from the time t9 as the start timing to the time t12 as the end timing, the period from the time t12 as the start timing to the time t15 as the end timing corresponds to the cycle Ta.

Then, the control circuit 100 raises the latch signal LAT at the timing when the logic levels of the input position information signals cENa and cENb change, based on the cycle Ta. At the rising edge of the latch signal LAT, the cycle Tp in which the print head 22 discharges ink to the medium P to form dots on the medium P is defined. Here, as illustrated in FIG. 13, the control circuit 100 may raise the latch signal LAT to be output at the timing when the logic levels of the position information signals cENa and cENb change, that is, at the timing defined by the cycle Ta, or may raise the latch signal LAT to be output at the timing based on changes in the logic levels of the position information signals cENa and cENb, that is, at the timing obtained by multiplying or dividing the cycle Ta.

Then, the carriage 21 stops when the scanning position of the carriage 21 reaches a predetermined stop position on the other side along the scanning axis. Then, the supply of the base position information signals ENa and ENb as the base position information signal ENC to the conversion circuit 300 is stopped, and the conversion circuit 300 stops the output of the position information signal cENC whose logic level changes. At this time, the input of a pulse signal as the composite edge signal eEG to the edge count circuit 320 included in the conversion circuit 300 is also stopped. When the edge of the pulse signal as the composite edge signal eEG is not detected for a predetermined period, the edge count circuit 320 resets the count value included in the edge count signal eCNT to be output. As a result, when the movement of the carriage 21 is resumed, the operation from the time t0 illustrated in FIG. 13 is repeatedly executed.

Here, when the carriage 21 is moved from one side to the other side along the scanning axis and when the carriage 21 is moved from the other side to one side along the scanning axis, the output circuit 340 executes the same operation except for the timing when the logic levels of the base position information signals fENa and fENb input to the output circuit 340 change and the timing when the logic levels of the position information signals cENa and cENb to be output change.

Specifically, when the carriage 21 is moved from the other side to one side along the scanning axis, the base position information signal fENa and the base position information signal fENb that leads the base position information signal fENa by 90 degrees in phase are input to the output circuit 340. The output circuit 340 executes the same operation as that when the carriage 21 is moved from one side to the other side along the scanning axis, according to the input base position information signals fENa and fENb, to define the timings corresponding to the times t6, t9, t12, and t15 illustrated in FIG. 13 which are the timings when the logic levels of the position information signals cENa and cENb to be output are converted.

Then, during the movement of the carriage 21 from the other side to one side along the scanning axis, when the logic levels of the position information signals cENa and the position information signal cENb being output are the same immediately before the timing when the logic levels of the position information signals cENa and cENb are converted, the output circuit 340 inverts the logic level of the position information signal cENb to be output at the timing when the logic levels of the position information signals cENa and cENb are converted. On the other hand, during the movement of the carriage 21 from the other side to one side along the scanning axis, when the logic levels of the position information signals cENa and the position information signal cENb being output are different from each other immediately before the timing when the logic levels of the position information signals cENa and cENb are converted, the output circuit 340 inverts the logic level of the position information signal cENa at the timing when the logic levels of the position information signals cENa and cENb are converted. That is, when the carriage 21 is moved from the other side to one side along the scanning axis, the output circuit 340 outputs the position information signal cENa and the position information signal cENb that leads the position information signal cENa by 90 degrees in phase.

Here, in the output circuit 340, the count value of the number of rising edges of the clock signal CLK included in the clock count signal cCNT output by the clock count circuit 330, which is the count value of the number of pulse cycles of the clock signal CLK, is used during a period in which the scanning position of the carriage 21 is corrected, such as the periods pc1, pc2, pc3, pc4, and the like in the example illustrated in FIG. 13. Therefore, the clock count circuit 330 may stop the operation during a period other than a period in which the scanning position of the carriage 21 is corrected, such as the periods pc1, pc2, pc3, pc4, and the like in the example illustrated in FIG. 13.

Here, the encoder unit 90 is an example of a position detection circuit, the conversion circuit 300 is an example of a signal conversion circuit, the edge count circuit 320 is an example of a first count circuit, the clock count circuit 330 is an example of a second count circuit, and the output circuit 340 is an example of an output circuit. In addition, the clock signal CLK is an example of a clock signal, the value of the conversion timing information eCV is an example of a first predetermined value, and the value of the conversion timing information cCV is an example of a second predetermined value. In addition, the unit system indicating the distance conforming to the Imperial system is an example of the inch unit system, and the unit system indicating the distance conforming to the metric system is an example of the millimeter unit system.

### 5. Operation and Effect

In the printing apparatus 1 according to the present embodiment configured as described above, the conversion circuit 300 including the output circuit 340 acquires the base position information signals ENa and ENb, which are the base position information signal ENC output by the encoder unit 90, and the clock signal CLK having a predetermined cycle, and outputs the position information signal cENC including the position information signals cENa and cENb corresponding to the sum of at least one edge interval among the edge intervals of the base position information signals ENa and ENb, which are the base position information signal ENC, and at least one pulse cycle among the pulse cycles of the clock signal CLK. Specifically, in the printing apparatus 1 according to the present embodiment, the output circuit 340 outputs the position information signal cENC including the position information signal cENa, whose logic level changes, at the timing at which the count result of the number of pulses of the clock signal CLK in the clock count circuit 330 reaches the value defined by the conversion timing information cCV, after the count result of the number of edges of the base position information signals fENa and fENb which are the base position information signal ENC, which is the count result of the number of edges of the base position information signals ENa and ENb which are the base position information signal ENC in the edge count circuit 320, reaches the value defined by the conversion timing information eCV.

As a result, the error that occurs in the scanning position of the print head 22 defined by the edge interval of the base position information signals ENa and ENb, which are the base position information signal ENC, with respect to the ideal scanning position of the print head 22, can be corrected based on the distance by which the print head 22 moves during the pulse cycle of the clock signal CLK. As a result, the accuracy of the timing of image formation on the medium P by the print head 22 is improved, and the quality of the image formed on the medium P is improved.

As a result, the encoder unit 90 can output the base position information signal ENC whose logic level changes according to the change in the relative position between the print head 22 and the medium P in the “millimeter unit system” based on μm or mm, and the conversion circuit 300 can output the base position information signal ENC as the position information signal cENC whose logic level changes according to the change in the relative position between the print head 22 and the medium P in the “inch unit system” based on inches, and in the printing apparatus 1 in which the “inch unit system” is widely used, particularly significant effects are achieved.

The embodiments and the modification examples were described above. However, the present disclosure is not limited to the embodiments and can be implemented in various aspects without departing from the gist of the present disclosure. For example, the above-described embodiments can also be combined with each other as appropriate.

The present disclosure includes substantially the same configurations (for example, configurations having the same functions, methods, and results, or configurations having the same objects and effects) as the configurations described in the embodiments. The present disclosure also includes configurations obtained by replacing non-essential parts of the configurations described in the embodiment. The present disclosure also includes configurations achieving the same operation and effect or configurations that can achieve the same object as the configurations described in the embodiment. In addition, the present disclosure includes configurations in which a known technology is added to the configurations described in the embodiments.

The following content is derived from the above-described embodiments.

An aspect of a printing apparatus includes a print head that forms a dot on a medium at a timing defined by a position information signal, a position detection circuit that outputs a base position information signal corresponding to a change in a relative position between the medium and the print head, and a signal conversion circuit to which the base position information signal is input and which outputs the position information signal corresponding to the base position information signal, in which the signal conversion circuit acquires the base position information signal and a clock signal, and outputs the position information signal corresponding to a sum of at least one edge interval of the base position information signal and at least one pulse cycle of the clock signal.

According to the printing apparatus, the signal conversion circuit acquires the base position information signal corresponding to the change in the relative position between the medium and the print head, which is output by the position detection circuit, and the clock signal having a predetermined cycle, and defines the timing at which the print head forms the dot on the medium in accordance with the sum of at least one edge interval of the base position information signal and at least one pulse cycle of the clock signal, so that the error that occurs when the timing at which the print head forms the dot on the medium is defined by only the base position information signal corresponding to the change in the relative position between the medium and the print head, which is output by the position detection circuit, can be corrected in accordance with the pulse cycle of the clock signal. As a result, the timing accuracy of the image formation on the medium by the print head is improved, and the quality of the image formed on the medium can be improved.

In an aspect of the printing apparatus, the pulse cycle may be shorter than the edge interval.

According to the printing apparatus, the error that occurs when the timing at which the print head forms the dot on the medium is defined by only the base position information signal corresponding to the change in the relative position between the medium and the print head, which is output by the position detection circuit, can be accurately corrected in accordance with the pulse cycle of the clock signal. As a result, the timing accuracy of the image formation on the medium by the print head is further improved, and the quality of the image formed on the medium can be further improved.

In an aspect of the printing apparatus, the position detection circuit may output the base position information signal whose logic level changes according to a change in the relative position in a millimeter unit system, and the signal conversion circuit may convert the base position information signal into a signal whose logic level changes according to a change in the relative position in an inch unit system, and output the signal as the position information signal.

According to the printing apparatus, the error that occurs when the timing at which the print head forms the dot on the medium is defined by only the base position information signal corresponding to the change in the relative position between the medium and the print head, which is output by the position detection circuit, can be corrected in accordance with the pulse cycle of the clock signal, so that the timing accuracy of the image formation on the medium by the print head is improved, and the quality of the image formed on the medium can be improved even when the position detection circuit outputs the base position information signal whose logic level changes according to the change in the relative position in the millimeter unit system, and the signal conversion circuit converts the base position information signal into a signal whose logic level changes according to the change in the relative position in the inch unit system, and outputs the signal as the position information signal.

In an aspect of the printing apparatus, the position detection circuit may be an optical encoder.

According to the printing apparatus, even when the optical encoder is used as the position detection circuit, the error that occurs when the timing at which the print head forms the dot on the medium is defined by only the base position information signal corresponding to the change in the relative position between the medium and the print head, which is output by the position detection circuit, can be accurately corrected in accordance with the pulse cycle of the clock signal, so that the timing accuracy of the image formation on the medium by the print head is further improved, and the quality of the image formed on the medium can be further improved.

In an aspect of the printing apparatus, the position detection circuit may be a magnetic encoder.

According to the printing apparatus, even when the magnetic encoder is used as the position detection circuit, the error that occurs when the timing at which the print head forms the dot on the medium is defined by only the base position information signal corresponding to the change in the relative position between the medium and the print head, which is output by the position detection circuit, can be accurately corrected in accordance with the pulse cycle of the clock signal, so that the timing accuracy of the image formation on the medium by the print head is further improved, and the quality of the image formed on the medium can be further improved.

In an aspect of the printing apparatus, there may be provided a carriage on which the print head is mounted and which is moved along a scanning axis, in which the signal conversion circuit may output the position information signal during an acceleration period in which the carriage accelerates, a constant speed period in which the carriage is moved at a constant speed, and a deceleration period in which the carriage decelerates.

According to the printing apparatus, the error that occurs when the timing at which the print head forms the dot on the medium is defined by only the base position information signal corresponding to the change in the relative position between the medium and the print head, which is output by the position detection circuit, can be corrected in accordance with the pulse cycle of the clock signal, and the timing accuracy of the image formation on the medium by the print head is improved, and the quality of the image formed on the medium can be improved even during any of the acceleration period, the constant speed period, and the deceleration period.

In an aspect of the printing apparatus, the signal conversion circuit may include a first count circuit that counts the number of edges of the base position information signal, a second count circuit that counts the number of pulses of the clock signal, and an output circuit that outputs the position information signal whose logic level changes at a timing at which a count result of the second count circuit reaches a second predetermined value, after a count result of the first count circuit reaches a first predetermined value.

According to the printing apparatus, the signal conversion circuit acquires the base position information signal corresponding to the change in the relative position between the medium and the print head, which is output by the position detection circuit, and the clock signal having a predetermined cycle, and at the timing which is the sum of at least one edge interval of the base position information signal and at least one pulse cycle of the clock signal and at which the count result of counting the number of pulses of the clock signal in the second count circuit reaches the second predetermined value after the count result of counting the number of edges of the base position information signal in the first count circuit reaches the first predetermined value, the output circuit outputs the position information signal whose logic level changes and the timing at which the print head forms the dot on the medium is defined by the position information signal output by the output circuit, so that the error that occurs when the timing at which the print head forms the dot on the medium is defined by only the base position information signal corresponding to the change in the relative position between the medium and the print head, which is output by the position detection circuit, can be corrected in accordance with the pulse cycle of the clock signal. As a result, the timing accuracy of the image formation on the medium by the print head is improved, and the quality of the image formed on the medium can be improved.

In an aspect of the printing apparatus, the count result of the second count circuit may be reset at a timing at which a logic level of the base position information signal changes.

According to the printing apparatus, a storage region in which the second count circuit holds the count result can be reduced.

In an aspect of the printing apparatus, the first predetermined value and the second predetermined value may be rewritable.

According to the printing apparatus, the first predetermined value and the second predetermined value can be appropriately changed in accordance with the specification of the printing apparatus, and the versatility of the printing apparatus in which the timing accuracy of the image formation on the medium by the print head is improved and the quality of the image formed on the medium is improved can be enhanced.

What is claimed is:

1. A printing apparatus comprising:
a print head that forms a dot on a medium at a timing defined by a position information signal;
a position detection circuit that outputs a base position information signal corresponding to a change in a relative position between the medium and the print head; and
a signal conversion circuit to which the base position information signal is input and which outputs the position information signal corresponding to the base position information signal, wherein
the signal conversion circuit acquires the base position information signal and a clock signal, and outputs the position information signal corresponding to a sum of at least one edge interval of the base position information signal and at least one pulse cycle of the clock signal.

2. The printing apparatus according to claim 1, wherein
the pulse cycle is shorter than the edge interval.

3. The printing apparatus according to claim 1, wherein
the position detection circuit outputs the base position information signal whose logic level changes according to a change in the relative position in a millimeter unit system, and
the signal conversion circuit converts the base position information signal into a signal whose logic level changes according to a change in the relative position in an inch unit system, and outputs the signal as the position information signal.

4. The printing apparatus according to claim 1, wherein
the position detection circuit is an optical encoder.

5. The printing apparatus according to claim 1, wherein
the position detection circuit is a magnetic encoder.

6. The printing apparatus according to claim 1, further comprising:
a carriage on which the print head is mounted and which is moved along a scanning axis, wherein
the signal conversion circuit outputs the position information signal during an acceleration period in which the carriage accelerates, a constant speed period in which the carriage is moved at a constant speed, and a deceleration period in which the carriage decelerates.

7. The printing apparatus according to claim 1, wherein
the signal conversion circuit includes
a first count circuit that counts the number of edges of the base position information signal,
a second count circuit that counts the number of pulses of the clock signal, and
an output circuit that outputs the position information signal whose logic level changes at a timing at which a count result of the second count circuit reaches a second predetermined value, after a count result of the first count circuit reaches a first predetermined value.

8. The printing apparatus according to claim 7, wherein
the count result of the second count circuit is reset at a timing at which a logic level of the base position information signal changes.

9. The printing apparatus according to claim 7, wherein
the first predetermined value and the second predetermined value are rewritable.
